(19) United States
(12) Patent Application Publication
(10) Pub. No.: US 2019/0364295 A1
(43) Pub. Date: Nov. 28, 2019

(54) METHOD AND APPARATUS FOR VIDEO CODING

(71) Applicant: TENCENT AMERICA LLC, Palo Alto, CA (US)

(72) Inventors: Guichun LI, Milpitas, CA (US); Xiaozhong XU, State College, PA (US); Shan LIU, San Jose, CA (US); Xiang LI, Los Gatos, CA (US)

(73) Assignee: TENCENT AMERICA LLC, Palo Alto, CA (US)

(21) Appl. No.: 16/235,818

(22) Filed: Dec. 28, 2018

Related U.S. Application Data
(60) Provisional application No. 62/676,905, filed on May 25, 2018.
(60) Provisional application No. 62/676,910, filed on May 25, 2018.
(60) Provisional application No. 62/676,915, filed on May 25, 2018.
(60) Provisional application No. 62/676,916, filed on May 25, 2018.

(51) Int. Cl. H04N 19/52; H04N 19/105; H04N 19/176; H04N 19/184

(52) U.S. Cl. CPC H04N 19/52; H04N 19/184; H04N 19/176; H04N 19/105

(57) ABSTRACT

Aspects of the disclosure provide a method and an apparatus including processing circuitry for video coding. The processing circuitry decodes prediction information of a block of a current picture in a coded video bitstream and determines a motion prediction mode based on the prediction information. The processing circuitry determines that the block is to be predicted based on multiple reference pictures that include a first and a second reference pictures. The processing circuitry obtains, based on the prediction information, first motion vector (MV) prediction information for the first reference picture and determines second MV prediction information for the second reference picture based on the first MV prediction information, the motion prediction mode, and temporal relationships among the first, the second, and the current pictures in a video sequence. The processing circuitry reconstructs a sample in the block based on the first and the second MV prediction information.

### INCORPORATION BY REFERENCE

This present disclosure claims the benefit of priority to U.S. Provisional Application No. 62/676,905, “Methods for affine motion compensation using multiple segments” filed on May 25, 2018, U.S. Provisional Application No. 62/676,910, “Methods for bi-directional motion compensation using extrapolated motion models” filed on May 25, 2018, U.S. Provisional Application No. 62/676,912, “Methods for bi-directional motion compensation using mirrored motion models” filed on May 25, 2018, U.S. Provisional Application No. 62/676,915, “Methods for bi-directional motion compensation using simplified rotation motion models” filed on May 25, 2018, U.S. Provisional Application No. 62/676,916, “Methods for bi-directional motion compensation using simplified scaling motion models” filed on May 25, 2018, which are incorporated by references herein in their entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Video coding and decoding can be performed using inter-picture prediction with motion compensation. Uncompressed digital video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GBytes of storage space.

One purpose of video coding and decoding can be the reduction of redundancy in the input video signal, through compression. Compression can help reduce the aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signals is small enough to make the reconstructed signal useful for the intended application. In the case of video, lossy compression is widely employed. The amount of distortion tolerated depends on the application; for example, users of certain consumer streaming applications may tolerate higher distortion than users of television distribution applications. The compression ratio achievable can reflect that: higher allowable/tolerable distortion can yield higher compression ratios.

Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part. In some cases, the reference picture can be the same as the picture currently under reconstruction. MVs can have two dimensions X and Y, or three dimensions, the third being an indication of the reference picture in use (the latter, indirectly, can be a time dimension).

In some video compression techniques, an MV applicable to a certain area of sample data can be predicted from other MVs, for example from those related to another area of sample data spatially adjacent to the area under reconstruction, and preceding that MV in decoding order. Doing so can substantially reduce the amount of data required for coding the MV, thereby removing redundancy and increasing compression. MV prediction can work effectively, for example, because when coding an input video signal derived from a camera (known as natural video) there is a statistical likelihood that areas larger than the area to which a single MV is applicable move in a similar direction and, therefore, can in some cases be predicted using a similar motion vector derived from MVs of neighboring area. That results in the MV found for a given area to be similar or the same as the MV predicted from the surrounding MVs, and that in turn can be represented, after entropy coding, in a smaller number of bits than what would be used if coding the MV directly. In some cases, MV prediction can be an example of lossless compression of a signal (namely: the MVs) derived from the original signal (namely: the sample stream). In other cases, MV prediction itself can be lossy, for example because of rounding errors when calculating a predictor from several surrounding MVs.

Various MV prediction mechanisms are described in H.265/HEVC (ITU-T Rec. H.265, “High Efficiency Video Coding”, December 2016). Out of the many MV prediction mechanisms that H.265 offers, described here is a technique henceforth referred to as “spatial merge”.

Referring to FIG. 1, a current block (101) comprises samples that have been found by the encoder during the motion search process to be predictable from a previous block of the same size that has been spatially shifted. Instead of coding that MV directly, the MV can be derived from metadata associated with one or more reference pictures, for example from the most recent (in decoding order) reference picture, using the MV associated with either one of five surrounding samples, denoted A0, A1, and B0, B1, B2 (102 through 106, respectively). In H.265, the MV prediction can use predictors from the same reference picture that the neighboring block is using.

### SUMMARY

Aspects of the disclosure provide a method and an apparatus for video coding. In some examples, the apparatus includes processing circuitry. The processing circuitry decodes prediction information of a block of a current picture in a coded video bitstream, and determines a motion prediction mode based on the prediction information. The processing circuitry determines that the block of the current picture is to be predicted based on multiple reference pictures where the multiple reference pictures include a first reference picture and a second reference picture that are in a video sequence including the current picture. The processing circuitry obtains, based on the prediction information, first motion vector (MV) prediction information for the first reference picture. The processing circuitry further determines second MV prediction information for the second reference picture based on the first MV prediction information, the motion prediction mode, and temporal relationships among the first, the second, and the current pictures in the video sequence. The processing circuitry reconstructs a sample in the block based on a first sample in the first reference picture and a second sample in the second reference picture where a first position of the first sample is determined based on the first MV prediction information, and a second position of the second sample is determined based on the second MV prediction information.

In an embodiment, the prediction information includes an affine flag indicating that the motion prediction mode is an affine prediction mode where the affine flag is signaled in the coded video bitstream. The prediction information indicates that both the first and second reference pictures are one of before or after the current picture in the video sequence. The temporal relationships among the first, the second, and the current pictures in the video sequence include a first temporal distance of the current picture from the first reference picture and a second temporal distance of the current picture from the second reference picture.

In an example, the multiple reference pictures further include an additional reference picture that is to the one of before or after the current picture in the video sequence. The processing circuitry determines additional MV prediction information for the additional reference picture based on the first MV prediction information, the affine prediction mode, the first temporal distance, and an additional temporal distance of the current picture from the additional reference picture. The processing circuitry then reconstructs the sample in the block further based on an additional sample in the additional reference picture where a position of the additional sample is determined based on the additional MV prediction information.

In an example, the affine prediction mode is implemented in a merge mode and a merge candidate list includes a first MV prediction candidate for the first reference picture identified in a first picture list. The processing circuitry determines, based on the first MV prediction candidate, the affine prediction mode, the first temporal distance, and the second temporal distance, a second MV prediction candidate for the second reference picture identified in a second list. The processing circuitry then generates, for the merge candidate list, a bi-prediction candidate that includes the first MV prediction candidate and the second MV prediction candidate where the first MV prediction information corresponds to the first MV prediction candidate and the second MV prediction information corresponds to the second MV prediction candidate.

In an embodiment, the prediction information includes an affine flag indicating that the motion prediction mode is an affine prediction mode where the affine flag is signaled in the coded video bitstream. The prediction information indicates that the first and second reference pictures are in opposite directions relative to the current picture in the video sequence. Further, the first MV prediction information for the first reference picture is signaled in the coded video bitstream, and the temporal relationships among the first, the second, and the current pictures in the video sequence include a first temporal distance of the current picture from the first reference picture. In an example, the first temporal distance is equal to a second temporal distance of the current picture from the second reference picture.

In an example, the affine prediction mode is implemented in a merge mode and a merge candidate list includes a first MV prediction candidate for the first reference picture identified in a first picture list. The processing circuitry determines a second MV prediction candidate for the second reference picture identified in a second list based on the first MV prediction candidate, the affine prediction mode, and the first temporal distance. The processing circuitry further generates, for the merge candidate list, a bi-prediction candidate that includes the first MV prediction candidate and the second MV prediction candidate where the first MV prediction information corresponds to the first MV prediction candidate and the second MV prediction information corresponds to the second MV prediction candidate.

In an embodiment, the prediction information includes an affine flag indicating that the motion prediction mode is an affine prediction mode limited to rotation and translation of the block with respect to the first and second reference pictures where the affine flag is signaled in the coded video bitstream. The prediction information indicates that the first and second reference pictures are in opposite directions relative to the current picture in the video sequence. The first MV prediction information including a first angular parameter and a first translation MV is signaled in the coded bitstream where the first angular parameter indicates the rotation and the first translation MV indicates the translation of the block with respect to the first reference picture. The processing circuitry determines the second MV prediction information including a second angular parameter indicating the rotation and a second translation MV indicating the translation of the block with respect to the second reference picture based on the first MV prediction information where the affine prediction mode is limited to the rotation and the translation of the block with respect to the first and second reference pictures and the temporal relationships include a first temporal distance of the current picture from the first reference picture and a second temporal distance of the current picture from the second reference picture.

In an example, the affine prediction mode is implemented in a merge mode and a merge candidate list includes a first MV prediction candidate for the first reference picture identified in a first picture list. The processing circuitry determines a second MV prediction candidate for the second reference picture identified in a second list based on the first MV prediction candidate, the affine prediction mode limited to the rotation and the translation of the block with respect to the first and second reference pictures, the first temporal distance, and the second temporal distance. The processing circuitry generates, for the merge candidate list, a bi-prediction candidate that includes the first MV prediction candidate and the second MV prediction candidate where the first MV prediction information corresponds to the first MV prediction candidate and the second MV prediction information corresponds to the second MV prediction candidate.

In an embodiment, the prediction information includes an affine flag indicating that the motion prediction mode is an affine prediction mode limited to scaling and translation of the block with respect to the first and second reference pictures where the affine flag is signaled in the coded video bitstream. The prediction information indicates that the first and second reference pictures are in opposite directions relative to the current picture in the video sequence. The first MV prediction information including a first scaling parameter and a first translation MV is signaled in the coded bitstream where the first scaling parameter indicates the scaling and the first translation MV indicates the translation of the block with respect to the first reference picture. The processing circuitry determines the second MV prediction information including a second scaling parameter indicating the scaling and a second translation MV indicating the translation of the block with respect to the second reference picture based on the first MV prediction information, the affine prediction mode limited to the scaling and the translation of the block with respect to the first and second reference pictures, and the temporal relationships including a first temporal distance of the current picture from the first reference picture and a second temporal distance of the current picture from the second reference picture.

In an example, the affine prediction mode is implemented in a merge mode and a merge candidate list includes a first MV prediction candidate for the first reference picture identified in a first picture list. The processing circuitry determines a second MV prediction candidate for the second reference picture identified in a second list based on the first MV prediction candidate and the affine prediction mode limited to the scaling and the translation of the block with respect to the first and second reference pictures, the first temporal distance, and the second temporal distance. The processing circuitry generates, for the merge candidate list, a bi-prediction candidate that includes the first MV prediction candidate and the second MV prediction candidate where the first MV prediction information corresponds to the first MV prediction candidate and the second MV prediction information corresponds to the second MV prediction candidate.

Aspects of the disclosure provide a method and an apparatus for video coding. In some embodiments, the apparatus includes processing circuitry. The processing circuitry decodes prediction information of a block of a picture in a coded video bitstream, and determines that the block is to be split into multiple segments that are predicted with respective affine prediction modes. The processing circuitry divides, based on the prediction information, the block into the multiple segments including a first segment and a second segment where samples in the first segment are predicted based on a first affine prediction mode having a first set of parameters and samples in the second segment are predicted based on a second affine prediction mode having a second set of parameters.

Aspects of the disclosure also provide a non-transitory computer-readable storage medium storing a program executable by at least one processor for video coding to perform any of the methods for video coding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a current block and its surrounding spatial merge candidates in one example.

FIG. 2 is a schematic illustration of a simplified block diagram of a communication system (200) in accordance with an embodiment.

FIG. 3 is a schematic illustration of a simplified block diagram of a communication system (300) in accordance with an embodiment.

FIG. 4 is a schematic illustration of a simplified block diagram of a decoder in accordance with an embodiment.

FIG. 5 is a schematic illustration of a simplified block diagram of an encoder in accordance with an embodiment.

FIG. 6 shows a block diagram of an encoder in accordance with another embodiment.

FIG. 7 shows a block diagram of a decoder in accordance with another embodiment.

FIG. 8 shows an affine motion model in accordance with an embodiment.

FIG. 9A shows a 6-parameter affine motion model in accordance with an embodiment.

FIG. 9B shows a 4-parameter affine motion model in accordance with an embodiment.

FIG. 10 shows a current block and neighboring blocks in accordance with an embodiment.

FIG. 11A shows a propagation of zooming in the time domain in accordance with an embodiment.

FIG. 11B shows a propagation of rotation in the time domain in accordance with an embodiment.

FIG. 12A-12B show linear scaling in accordance with an embodiment.

FIG. 13 shows an example corresponding to translation (or translation motion) in accordance with an embodiment.

FIG. 14A shows a propagation of zooming in the time domain in accordance with an embodiment.

FIG. 14B shows a propagation of rotation in the time domain in accordance with an embodiment.

FIG. 15A-15B show linear scaling in accordance with embodiments.

FIG. 16 shows translation motion in accordance with an embodiment.

FIG. 17 shows an example of dividing a current block into multiple segments in in accordance with an embodiment.

FIG. 18 shows a flow chart outlining a process in accordance with an embodiment.

FIG. 19 shows a flow chart outlining a process in accordance with an embodiment.

FIG. 20 is a schematic illustration of a computer system in accordance with an embodiment.

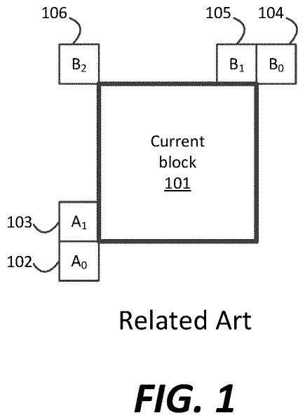

### DETAILED DESCRIPTION OF EMBODIMENTS

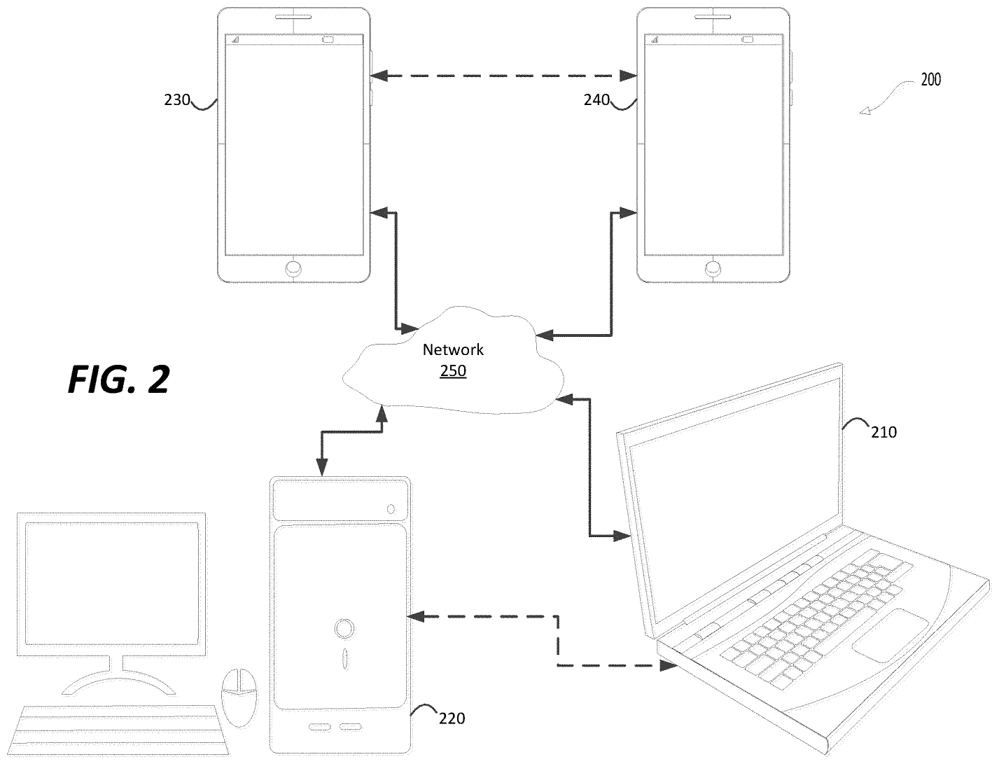

FIG. 2 illustrates a simplified block diagram of a communication system (200) according to an embodiment of the present disclosure. The communication system (200) includes a plurality of terminal devices that can communicate with each other, via, for example, a network (250). For example, the communication system (200) includes a first pair of terminal devices (210) and (220) interconnected via the network (250). In the FIG. 2 example, the first pair of terminal devices (210) and (220) performs unidirectional transmission of data. For example, the terminal device (210) may code video data (e.g., a stream of video pictures that are captured by the terminal device (210)) for transmission to the other terminal device (220) via the network (250). The encoded video data can be transmitted in the form of one or more coded video bitstreams. The terminal device (220) may receive the coded video data from the network (250), decode the coded video data to recover the video pictures and display video pictures according to the recovered video data. Unidirectional data transmission may be common in media serving applications and the like.

In another example, the communication system (200) includes a second pair of terminal devices (230) and (240) that performs bidirectional transmission of coded video data that may occur, for example, during videoconferencing. For bidirectional transmission of data, in an example, each terminal device of the terminal devices (230) and (240) may code video data (e.g., a stream of video pictures that are captured by the terminal device) for transmission to the other terminal device of the terminal devices (230) and (240) via the network (250). Each terminal device of the terminal devices (230) and (240) also may receive the coded video data transmitted by the other terminal device of the terminal devices (230) and (240), and may decode the coded video data to recover the video pictures and may display video pictures at an accessible display device according to the recovered video data.

In the FIG. 2 example, the terminal devices (210), (220), (230) and (240) may be illustrated as servers, personal computers and smart phones but the principles of the present disclosure may be not so limited. Embodiments of the present disclosure find application with laptop computers, tablet computers, media players and/or dedicated video conferencing equipment. The network (250) represents any number of networks that convey coded video data among the terminal devices (210), (220), (230) and (240), including for example wireline (wired) and/or wireless communication networks. The communication network (250) may exchange data in circuit-switched and/or packet-switched channels. Representative networks include telecommunications networks, local area networks, wide area networks and/or the Internet. For the purposes of the present discussion, the architecture and topology of the network (250) may be immaterial to the operation of the present disclosure unless explained herein below.

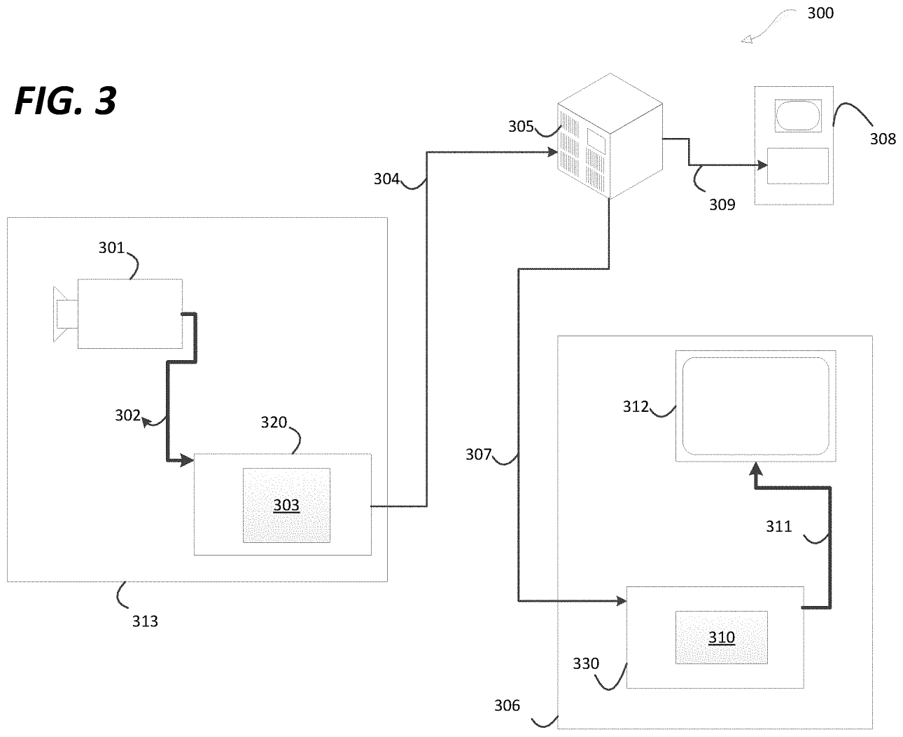

FIG. 3 illustrates, as an example for an application for the disclosed subject matter, the placement of a video encoder and a video decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem (313), that can include a video source (301), for example a digital camera, creating for example a stream of video pictures (302) that are uncompressed. In an example, the stream of video pictures (302) includes samples that are taken by the digital camera. The stream of video pictures (302), depicted as a bold line to emphasize a high data volume when compared to encoded video data (304) (or coded video bitstreams), can be processed by an electronic device (320) that includes a video encoder (303) coupled to the video source (301). The video encoder (303) can include hardware, software, or a combination thereof to enable or implement aspects of the disclosed subject matter as described in more detail below. The encoded video data (304) (or encoded video bitstream (304)), depicted as a thin line to emphasize the lower data volume when compared to the stream of video pictures (302), can be stored on a streaming server (305) for future use. One or more streaming client subsystems, such as client subsystems (306) and (308) in FIG. 3 can access the streaming server (305) to retrieve copies (307) and (309) of the encoded video data (304). A client subsystem (306) can include a video decoder (310), for example, in an electronic device (330). The video decoder (310) decodes the incoming copy (307) of the encoded video data and creates an outgoing stream of video pictures (311) that can be rendered on a display (312) (e.g., display screen) or other rendering device (not depicted). In some streaming systems, the encoded video data (304), (307), and (309) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (320) and (330) can include other components (not shown). For example, the electronic device (320) can include a video decoder (not shown) and the electronic device (330) can include a video encoder (not shown) as well.

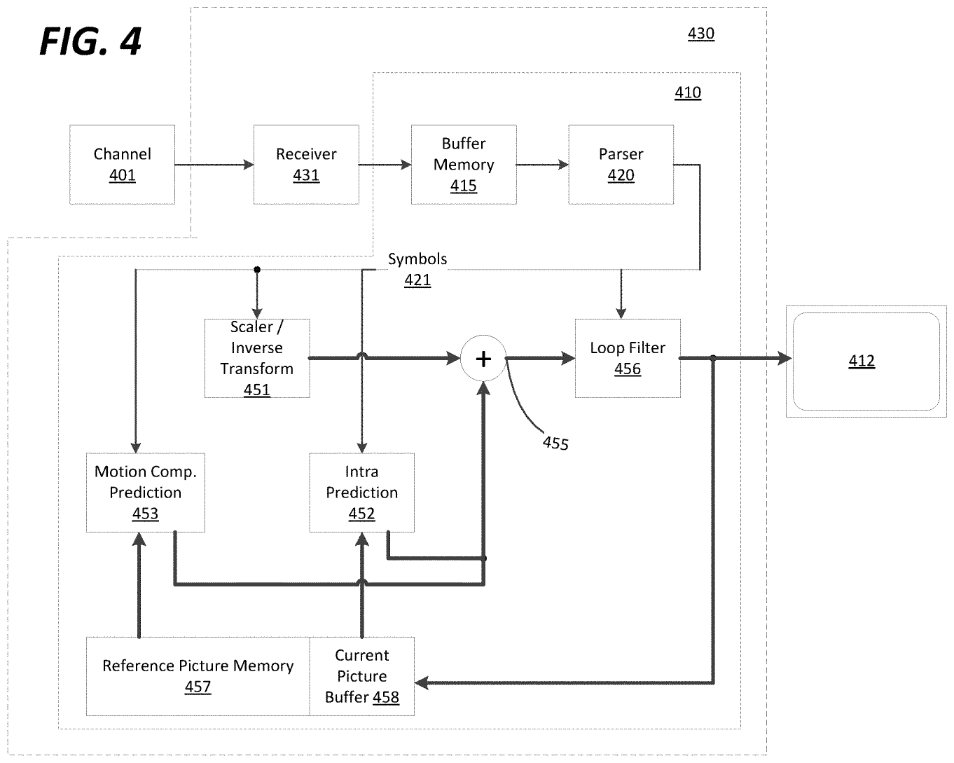

FIG. 4 shows a block diagram of a video decoder (410) according to an embodiment of the present disclosure. The video decoder (410) can be included in an electronic device (430). The electronic device (430) can include a receiver (431) (e.g., receiving circuitry). The video decoder (410) can be used in the place of the video decoder (310) in the FIG. 3 example.

The receiver (431) may receive one or more coded video sequences to be decoded by the video decoder (410); in the same or another embodiment, one coded video sequence at a time, where the decoding of each coded video sequence is independent from other coded video sequences. The coded video sequence may be received from a channel (401), which may be a hardware/software link to a storage device which stores the encoded video data. The receiver (431) may receive the encoded video data with other data, for example, coded audio data and/or ancillary data streams, that may be forwarded to their respective using entities (not depicted). The receiver (431) may separate the coded video sequence from the other data. To combat network jitter, a buffer memory (415) may be coupled in between the receiver (431) and an entropy decoder/parser (420) (“parser (420)” henceforth). In certain applications, the buffer memory (415) is part of the video decoder (410). In others, it can be outside of the video decoder (410) (not depicted). In still others, there can be a buffer memory (not depicted) outside of the video decoder (410), for example to combat network jitter, and in addition another buffer memory (415) inside the video decoder (410), for example to handle playout timing. When the receiver (431) is receiving data from a store/forward device of sufficient bandwidth and controllability, or from an isosynchronous network, the buffer memory (415) may not be needed, or can be small. For use on best effort packet networks such as the Internet, the buffer memory (415) may be required, can be comparatively large and can be advantageously of adaptive size, and may at least partially be implemented in an operating system or similar elements (not depicted) outside of the video decoder (410).

The video decoder (410) may include the parser (420) to reconstruct symbols (421) from the coded video sequence. Categories of those symbols include information used to manage operation of the video decoder (410), and potentially information to control a rendering device such as a render device (412) (e.g., a display screen) that is not an integral part of the electronic device (430) but can be coupled to the electronic device (430), as was shown in FIG. 4. The control information for the rendering device(s) may be in the form of Supplemental Enhancement Information (SEI messages) or Video Usability Information (VUI) parameter set fragments (not depicted). The parser (420) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (420) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (420) may also extract from the coded video sequence information such as transform coefficients, quantizer parameter values, motion vectors, and so forth.

The parser (420) may perform an entropy decoding/parsing operation on the video sequence received from the buffer memory (415), so as to create symbols (421).

Reconstruction of the symbols (421) can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser (420). The flow of such subgroup control information between the parser (420) and the multiple units below is not depicted for clarity.

Beyond the functional blocks already mentioned, the video decoder (410) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (451). The scaler/inverse transform unit (451) receives a quantized transform coefficient as well as control information, including which transform to use, block size, quantization factor, quantization scaling matrices, etc. as symbol(s) (421) from the parser (420). The scaler/inverse transform unit (451) can output blocks comprising sample values, that can be input into aggregator (455).

In some cases, the output samples of the scaler/inverse transform (451) can pertain to an intra coded block; that is: a block that is not using predictive information from previously reconstructed pictures, but can use predictive information from previously reconstructed parts of the current picture. Such predictive information can be provided by an intra picture prediction unit (452). In some cases, the intra picture prediction unit (452) generates a block of the same size and shape of the block under reconstruction, using surrounding already reconstructed information fetched from the current picture buffer (458). The current picture buffer (458) buffers, for example, partly reconstructed current picture and/or fully reconstructed current picture. The aggregator (455), in some cases, adds, on a per sample basis, the prediction information the intra prediction unit (452) has generated to the output sample information as provided by the scaler/inverse transform unit (451).

In other cases, the output samples of the scaler/inverse transform unit (451) can pertain to an inter coded, and potentially motion compensated block. In such a case, a motion compensation prediction unit (453) can access reference picture memory (457) to fetch samples used for prediction. After motion compensating the fetched samples in accordance with the symbols (421) pertaining to the block, these samples can be added by the aggregator (455) to the output of the scaler/inverse transform unit (451) (in this case called the residual samples or residual signal) so as to generate output sample information. The addresses within the reference picture memory (457) from where the motion compensation prediction unit (453) fetches prediction samples can be controlled by motion vectors, available to the motion compensation prediction unit (453) in the form of symbols (421) that can have, for example X, Y, and reference picture components. Motion compensation also can include interpolation of sample values as fetched from the reference picture memory (457) when sub-sample exact motion vectors are in use, motion vector prediction mechanisms, and so forth.

The output samples of the aggregator (455) can be subject to various loop filtering techniques in the loop filter unit (456). Video compression technologies can include in-loop filter technologies that are controlled by parameters included in the coded video sequence (also referred to as coded video bitstream) and made available to the loop filter unit (456) as symbols (421) from the parser (420), but can also be responsive to meta-information obtained during the decoding of previous (in decoding order) parts of the coded picture or coded video sequence, as well as responsive to previously reconstructed and loop-filtered sample values.

The output of the loop filter unit (456) can be a sample stream that can be output to the render device (412) as well as stored in the reference picture memory (457) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (420)), the current picture buffer (458) can become a part of the reference picture memory (457), and a fresh current picture buffer can be reallocated before commencing the reconstruction of the following coded picture.

The video decoder (410) may perform decoding operations according to a predetermined video compression technology in a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (431) may receive additional (redundant) data with the encoded video. The additional data may be included as part of the coded video sequence(s). The additional data may be used by the video decoder (410) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

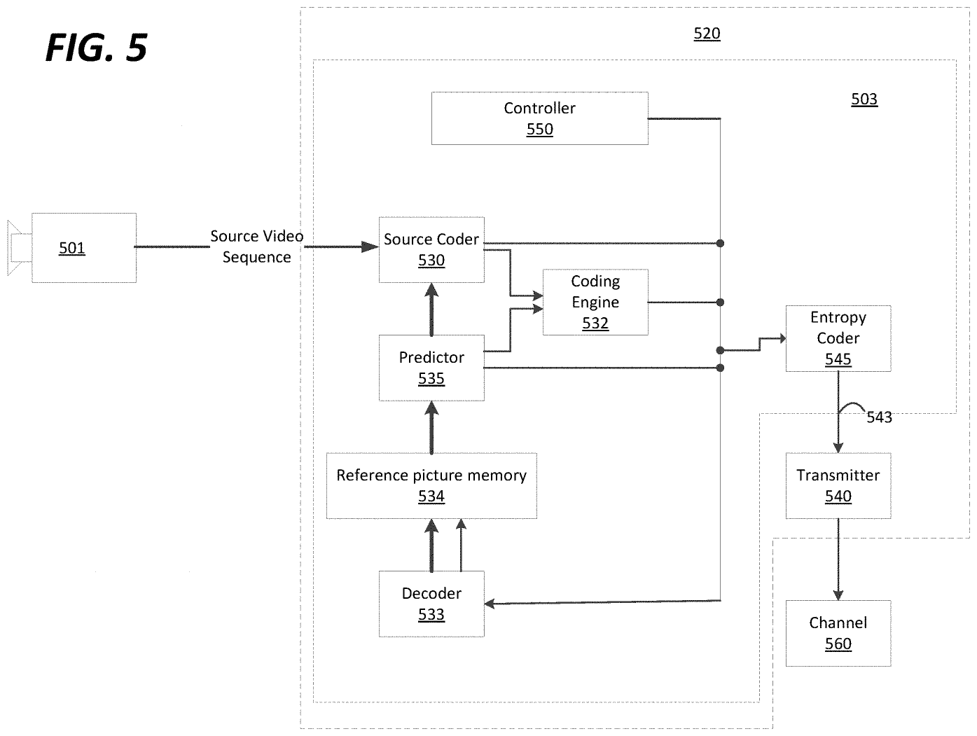

FIG. 5 shows a block diagram of a video encoder (503) according to an embodiment of the present disclosure. The video encoder (503) is included in an electronic device (520). The electronic device (520) includes a transmitter (540) (e.g., transmitting circuitry). The video encoder (503) can be used in the place of the video encoder (303) in the FIG. 3 example.

The video encoder (503) may receive video samples from a video source (501) (that is not part of the electronic device (520) in the FIG. 5 example) that may capture video image(s) to be coded by the video encoder (503). In another example, the video source (501) is a part of the electronic device (520).

The video source (501) may provide the source video sequence to be coded by the video encoder (503) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (501) may be a storage device storing previously prepared video. In a videoconferencing system, the video source (501) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the video encoder (503) may code and compress the pictures of the source video sequence into a coded video sequence (543) in real time or under any other time constraints as required by the application. Enforcing appropriate coding speed is one function of a controller (550). In some embodiments, the controller (550) controls other functional units as described below and is functionally coupled to the other functional units. The coupling is not depicted for clarity. Parameters set by the controller (550) can include rate control related parameters (picture skip, quantizer, lambda value of rate-distortion optimization techniques, . . . ), picture size, group of pictures (GOP) layout, maximum motion vector search range, and so forth. The controller (550) can be configured to have other suitable functions that pertain to the video encoder (503) optimized for a certain system design.

In some embodiments, the video encoder (503) is configured to operate in a coding loop. As an oversimplified description, in an example, the coding loop can include a source coder (530) (e.g., responsible for creating symbols, such as a symbol stream, based on an input picture to be coded, and a reference picture(s)), and a (local) decoder (533) embedded in the video encoder (503). The decoder (533) reconstructs the symbols to create the sample data in a similar manner as a (remote) decoder also would create (as any compression between symbols and coded video bitstream is lossless in the video compression technologies considered in the disclosed subject matter). The reconstructed sample stream (sample data) is input to the reference picture memory (534). As the decoding of a symbol stream leads to bit-exact results independent of decoder location (local or remote), the content in the reference picture memory (534) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (533) can be the same as of a “remote” decoder, such as the video decoder (410), which has already been described in detail above in conjunction with FIG. 4. Briefly referring also to FIG. 4, however, as symbols are available and encoding/decoding of symbols to a coded video sequence by an entropy coder (545) and the parser (420) can be lossless, the entropy decoding parts of the video decoder (410), including the buffer memory (415), and parser (420) may not be fully implemented in the local decoder (533).

An observation that can be made at this point is that any decoder technology except the parsing/entropy decoding that is present in a decoder also necessarily needs to be present, in substantially identical functional form, in a corresponding encoder. For this reason, the disclosed subject matter focuses on decoder operation. The description of encoder technologies can be abbreviated as they are the inverse of the comprehensively described decoder technologies. Only in certain areas a more detail description is required and provided below.

During operation, in some examples, the source coder (530) may perform motion compensated predictive coding, which codes an input picture predictively with reference to one or more previously-coded picture from the video sequence that were designated as “reference pictures”. In this manner, the coding engine (532) codes differences between pixel blocks of an input picture and pixel blocks of reference picture(s) that may be selected as prediction reference(s) to the input picture.

The local video decoder (533) may decode coded video data of pictures that may be designated as reference pictures, based on symbols created by the source coder (530). Operations of the coding engine (532) may advantageously be lossy processes. When the coded video data may be decoded at a video decoder (not shown in FIG. 5), the reconstructed video sequence typically may be a replica of the source video sequence with some errors. The local video decoder (533) replicates decoding processes that may be performed by the video decoder on reference pictures and may cause reconstructed reference pictures to be stored in the reference picture cache (534). In this manner, the video encoder (503) may store copies of reconstructed reference pictures locally that have common content as the reconstructed reference pictures that will be obtained by a far-end video decoder (absent transmission errors).

The predictor (535) may perform prediction searches for the coding engine (532). That is, for a new picture to be coded, the predictor (535) may search the reference picture memory (534) for sample data (as candidate reference pixel blocks) or certain metadata such as reference picture motion vectors, block shapes, and so on, that may serve as an appropriate prediction reference for the new pictures. The predictor (535) may operate on a sample block-by-pixel block basis to find appropriate prediction references. In some cases, as determined by search results obtained by the predictor (535), an input picture may have prediction references drawn from multiple reference pictures stored in the reference picture memory (534).

The controller (550) may manage coding operations of the source coder (530), including, for example, setting of parameters and subgroup parameters used for encoding the video data.

Output of all aforementioned functional units may be subjected to entropy coding in the entropy coder (545). The entropy coder (545) translates the symbols as generated by the various functional units into a coded video sequence, by lossless compressing the symbols according to technologies such as Huffman coding, variable length coding, arithmetic coding, and so forth.

The transmitter (540) may buffer the coded video sequence(s) as created by the entropy coder (545) to prepare for transmission via a communication channel (560), which may be a hardware/software link to a storage device which would store the encoded video data. The transmitter (540) may merge coded video data from the video coder (503) with other data to be transmitted, for example, coded audio data and/or ancillary data streams (sources not shown).

The controller (550) may manage operation of the video encoder (503). During coding, the controller (550) may assign to each coded picture a certain coded picture type, which may affect the coding techniques that may be applied to the respective picture. For example, pictures often may be assigned as one of the following picture types:

An Intra Picture (I picture) may be one that may be coded and decoded without using any other picture in the sequence as a source of prediction. Some video codecs allow for different types of intra pictures, including, for example Independent Decoder Refresh (“IDR”) Pictures. A person skilled in the art is aware of those variants of I pictures and their respective applications and features.

A predictive picture (P picture) may be one that may be coded and decoded using intra prediction or inter prediction using at most one motion vector and reference index to predict the sample values of each block.

A bi-directionally predictive picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (503) may perform coding operations according to a predetermined video coding technology or standard, such as ITU-T Rec. H.265. In its operation, the video encoder (503) may perform various compression operations, including predictive coding operations that exploit temporal and spatial redundancies in the input video sequence. The coded video data, therefore, may conform to a syntax specified by the video coding technology or standard being used.

In an embodiment, the transmitter (540) may transmit additional data with the encoded video. The source coder (530) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

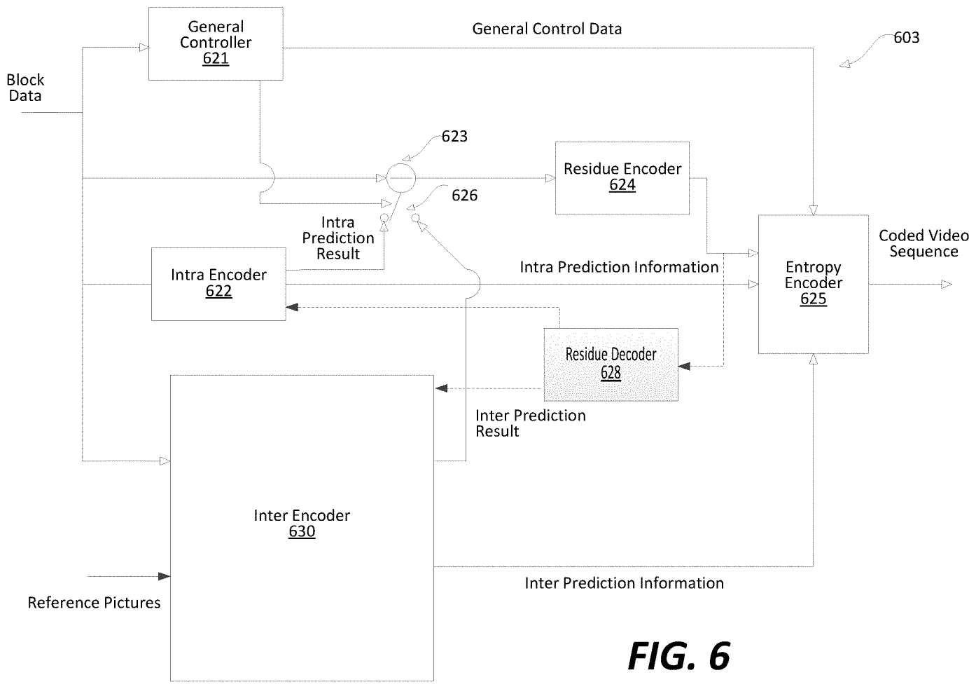

FIG. 6 shows a diagram of a video encoder (603) according to another embodiment of the disclosure. The video encoder (603) is configured to receive a processing block (e.g., a prediction block) of sample values within a current video picture in a sequence of video pictures, and encode the processing block into a coded picture that is part of a coded video sequence. In an example, the video encoder (603) is used in the place of the video encoder (303) in the FIG. 3 example.

In an HEVC example, the video encoder (603) receives a matrix of sample values for a processing block, such as a prediction block of 8×8 samples, and the like. The video encoder (603) determines whether the processing block is best coded using intra mode, inter mode, or bi-prediction mode using, for example, rate-distortion optimization. When the processing block is to be coded in intra mode, the video encoder (603) may use an intra prediction technique to encode the processing block into the coded picture; and when the processing block is to be coded in inter mode or bi-prediction mode, the video encoder (603) may use an inter prediction or bi-prediction technique, respectively, to encode the processing block into the coded picture. In certain video coding technologies, merge mode can be an inter picture prediction submode where the motion vector is derived from one or more motion vector predictors without the benefit of a coded motion vector component outside the predictors. In certain other video coding technologies, a motion vector component applicable to the subject block may be present. In an example, the video encoder (603) includes other components, such as a mode decision module (not shown) to determine the mode of the processing blocks.

In the FIG. 6 example, the video encoder (603) includes the inter encoder (630), an intra encoder (622), a residue calculator (623), a switch (626), a residue encoder (624), a general controller (621), and an entropy encoder (625) coupled together as shown in FIG. 6.

The inter encoder (630) is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The intra encoder (622) is configured to receive the samples of the current block (e.g., a processing block), in some cases compare the block to blocks already coded in the same picture, generate quantized coefficients after transform, and in some cases also intra prediction information (e.g., an intra prediction direction information according to one or more intra encoding techniques). In an example, the intra encoder (622) also calculates intra prediction results (e.g., predicted block) based on the intra prediction information and reference blocks in the same picture.

The general controller (621) is configured to determine general control data and control other components of the video encoder (603) based on the general control data. In an example, the general controller (621) determines the mode of the block, and provides a control signal to the switch (626) based on the mode. For example, when the mode is the intra mode, the general controller (621) controls the switch (626) to select the intra mode result for use by the residue calculator (623), and controls the entropy encoder (625) to select the intra prediction information and include the intra prediction information in the bitstream; and when the mode is the inter mode, the general controller (621) controls the switch (626) to select the inter prediction result for use by the residue calculator (623), and controls the entropy encoder (625) to select the inter prediction information and include the inter prediction information in the bitstream.

The residue calculator (623) is configured to calculate a difference (residue data) between the received block and prediction results selected from the intra encoder (622) or the inter encoder (630). The residue encoder (624) is configured to operate based on the residue data to encode the residue data to generate the transform coefficients. In an example, the residue encoder (624) is configured to convert the residue data from a spatial domain to a frequency domain, and generate the transform coefficients. The transform coefficients are then subject to quantization processing to obtain quantized transform coefficients. In various embodiments, the video encoder (603) also includes a residue decoder (628). The residue decoder (628) is configured to perform inverse-transform, and generate the decoded residue data. The decoded residue data can be suitably used by the intra encoder (622) and the inter encoder (630). For example, the inter encoder (630) can generate decoded blocks based on the decoded residue data and inter prediction information, and the intra encoder (622) can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder (625) is configured to format the bitstream to include the encoded block. The entropy encoder (625) is configured to include various information according to a suitable standard, such as the HEVC standard. In an example, the entropy encoder (625) is configured to include the general control data, the selected prediction information (e.g., intra prediction information or inter prediction information), the residue information, and other suitable information in the bitstream. Note that, according to the disclosed subject matter, when coding a block in the merge submode of either inter mode or bi-prediction mode, there is no residue information.

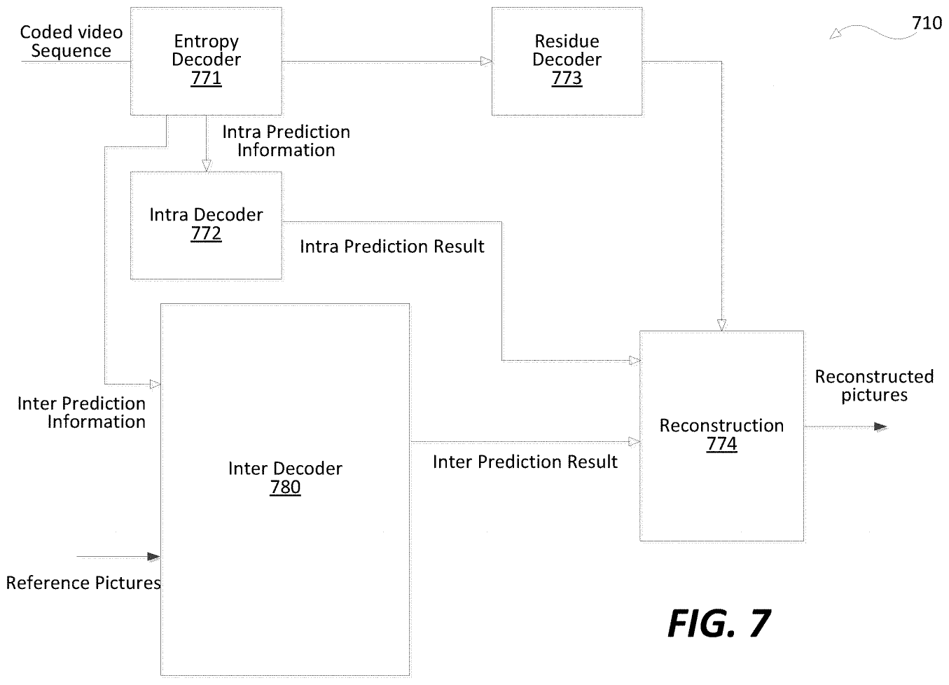

FIG. 7 shows a diagram of a video decoder (710) according to another embodiment of the disclosure. The video decoder (710) is configured to receive coded pictures that are part of a coded video sequence, and decode the coded pictures to generate reconstructed pictures. In an example, the video decoder (710) is used in the place of the video decoder (310) in the FIG. 3 example.

In the FIG. 7 example, the video decoder (710) includes an entropy decoder (771), an inter decoder (780), a residue decoder (773), a reconstruction module (774), and an intra decoder (772) coupled together as shown in FIG. 7.

The entropy decoder (771) can be configured to reconstruct, from the coded picture, certain symbols that represent the syntax elements of which the coded picture is made up. Such symbols can include, for example, the mode in which a block is coded (such as, for example, intra mode, inter mode, bi-predicted mode, the latter two in merge submode or another submode), prediction information (such as, for example, intra prediction information or inter prediction information) that can identify certain sample or metadata that is used for prediction by the intra decoder (772) or the inter decoder (780), respectively, residual information in the form of, for example, quantized transform coefficients, and the like. In an example, when the prediction mode is inter or bi-predicted mode, the inter prediction information is provided to the inter decoder (780); and when the prediction type is the intra prediction type, the intra prediction information is provided to the intra decoder (772). The residual information can be subject to inverse quantization and is provided to the residue decoder (773).

The inter decoder (780) is configured to receive the inter prediction information, and generate inter prediction results based on the inter prediction information.

The intra decoder (772) is configured to receive the intra prediction information, and generate prediction results based on the intra prediction information.

The residue decoder (773) is configured to perform inverse quantization to extract de-quantized transform coefficients, and process the de-quantized transform coefficients to convert the residual from the frequency domain to the spatial domain. The residue decoder (773) may also require certain control information (to include the Quantizer Parameter (QP)), and that information may be provided by the entropy decoder (771) (data path not depicted as this may be low volume control information only).

The reconstruction module (774) is configured to combine, in the spatial domain, the residual as output by the residue decoder (773) and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

It is noted that the video encoders (303), (503), and (603), and the video decoders (310), (410), and (710) can be implemented using any suitable technique. In an embodiment, the video encoders (303), (503), and (603), and the video decoders (310), (410), and (710) can be implemented using one or more integrated circuits. In another embodiment, the video encoders (303), (503), and (503), and the video decoders (310), (410), and (710) can be implemented using one or more processors that execute software instructions.

In general, motion compensation refers to techniques where one or more MVs are used to indicate a displacement of a sample or an area of samples relative to a position in a reference picture. In some embodiments, an affine motion compensation (also referred to as an affine prediction model, or an affine motion model), by describing a 6-parameter (or a simplified 4-parameter) affine motion model for a current block, can efficiently predict motion information for samples within the current block. More specifically, in an affine coded or described current block, different samples can have different MVs. A basic unit in the affine coded block where samples have a same MV is referred to as a sub-block. A size of the sub-block in the current block can range from one sample to a size of the current block. In an example, the sub-block includes 4×4 samples. The current block and the sub-block can have any suitable sizes and shapes, such as a rectangular shape or a non-rectangular shape.

When an affine motion model is determined for the current block, a MV of each sample in the current block relative to a reference picture can be derived based on the affine motion model. In order to reduce implementation complexity, an affine motion compensation can be performed for each sub-block instead of for each sample in the current block, as described above. Therefore, a MV of a sub-block can be derived, and MVs of samples in the sub-block are equal to the MV of the sub-block. A specific location, such as a top-left or a center of the sub-block, can be used to represent a sub-block location.

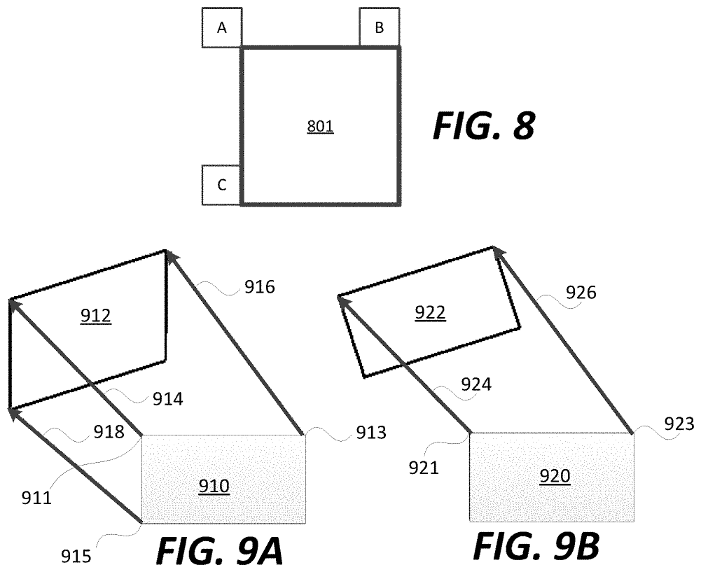

In some embodiments, an affine motion model can include multiple parameters, such as 6 parameters, 4 parameters, or any other number of desired parameters, to describe motion information (or MV prediction information) of a current block. In an example, the six (6) parameters of the affine motion model can be represented by three MVs at three different locations of an affine coded block. The three locations may be referred to as control points of the current block. FIG. 8 shows an example where three MVs of three corner positions A, B, and C of a current block (801) are used in an affine motion model. The three corner positions A, B, and C are the control points of the current block (801). In general, after an affine transformation described by the 6-parameter affine motion model, a rectangular block can be transformed into a parallelogram. FIG. 9A shows the 6-parameter affine motion model for a current block (910) with respect to a reference picture (912). Three MVs (914), (916), and (918) of three respective control points (911), (913), and (915) are used in the 6-parameter affine motion model.

In another example, an affine motion model can use 4 parameters where a shape of a current block does not change after an affine transformation described by the 4-parameter affine motion model. Therefore, a rectangular current block remains a rectangular shape and a same aspect ratio after the affine transformation. The 4-parameter affine motion model can be represented by a pair of MVs at two different locations (or control points), such as the corner positions A and B of the current block (801) in FIG. 8. FIG. 9B shows the 4-parameter affine motion model for a current block (920) with respect to a reference picture (922). Two MVs (924) and (926) of two respective control points (921) and (923) are used in the 4-parameter affine motion model.

In some embodiments, a merge mode and a residue mode (also referred to as a regular mode) can be used in motion prediction. When an affine motion compensation is used, the merge mode and/or the residue mode can be used in signaling. The merge mode refers to a MV prediction using one or more MV predictors (e.g., MVs associated with surrounding samples of a current block), but without using residual MV components. In the merge mode, an affine motion model of a current block can be predicted from one or more previously affine coded blocks. In an example, a reference block (i.e., one of the one or more previously affine coded blocks) and the current block are in a same affine object where MVs at control points of the current block can be derived from an affine motion model of the reference block. Residual MV components at the control points are assumed to be zero, and thus, are not signaled. In an example, which MV predictors, in what combination, and with what weighting among the MV predictors can be signaled as additional information (or side information). In another example, the side information can be predicted, and thus, is not explicitly signaled.

In the residue mode, an affine motion model of a current block including, for example, MVs at control points of a current block, may be predicted. Because more than one MV may be predicted, each candidate in a candidate list includes a set of MV predictors for the respective control points, such as the control points A, B, and C in FIG. 8. For example, candidate 1={a MV predictor1 for the control point A, a MV predictor1 for the control point B, and a MV predictor1 for the control point C}; candidate 2={ a MV predictor2 for the control point A, a MV predictor2 for the control point B, and a MV predictor2 for the control point C}. In other examples, three or more candidates may be used. A predictor for the same control point in different candidates can be the same or different. A MV predictor flag (e.g., a mvp_10_flag for a first reference picture list or a list 0 (L0) or a mvp_11_flag for a second reference picture list or a list 1 (L1)) can be used to indicate a candidate chosen from the respective reference picture list (e.g., the L0 or the L1). Further, residual MV components or differences between the MVs and respective MV predictors at the control points, may be signaled. Similarly, the side information can be coded explicitly or predicted. In a same picture coded in accordance with a given video coding technology, both the merge mode and the residue mode can be employed.

Techniques for MV prediction in an affine motion compensation described herein can be implemented in, or be part of, a video encoder or a video decoder. As already described above, encoders and decoders can implement similar techniques such as the MV prediction. Therefore, in the same or another embodiment, the disclosed subject matter can be part of a decoder or an encoder, respectively. For purposes of clarity, the description below is mainly for a decoder operation, and the description can be suitably adapted for an encoder operation.

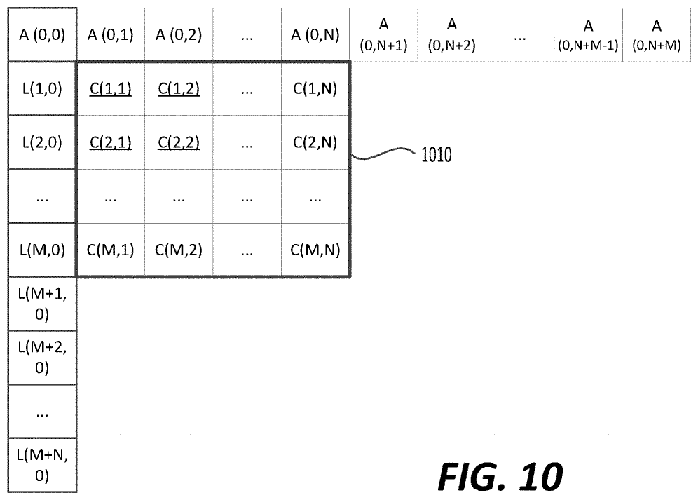

Referring to FIG. 10, when a current block (1010) under reconstruction is coded using the merge mode, displacements of samples in the current block (1010) can be derived from already decoded spatial/temporal neighboring blocks' motion information and without residual MV components. Therefore, the description below is mainly for the residue mode for purposes of clarity, and the description can be suitably adapted for the merge mode, for example, by making the residual MV components being zero. In the same or another embodiment, the current block (1010) being coded can include a plurality of sub-blocks C(1,1)-C(M, N) having any suitable shape, with or without gaps. For purposes of clarity, a rectangular array of the rectangular sub-blocks C(1,1)-C(M, N) is used in the description. Neighboring blocks or neighbors of the current block (1010) include A(0,0)-A(0,N+M) and L(1,0)-L(M+N,0).

A rectangular sub-block, such as the sub-block C(1,1) can include K×L samples, for example, K×L luminance samples. In some cases, similar sub-blocks of an equal or a similar size can derive MVs from a corresponding main sub-block. For example, in some video processing systems employing video decoders, a video is sampled in a YCrCb 4:2:0 sampling structure with chrominance samples Cr and Cb being subsampled and handled in respective chroma planes and luminance samples Y in a luminance plane, and thus, the main sub-block can be a sub-block having luminance samples Y. In another example, the main sub-block can be a green sub-block including green samples of a picture using a RGB color space, and red and blue samples are handled in respective red and blue color planes. In the above examples, sub-blocks in chroma or RB color planes can derive MVs from, for example, the main sub-blocks such as the luminance and the green sub-blocks, respectively. For purposes of clarity, the description is for a single-color plane. In the same or another embodiment, MVs can be predicted from coded information related to the single-color plane, even when a video bitstream includes information related to multiple color planes. In the same or another embodiment, motion information such as MVs for certain color planes can be derived from motion information such as MVs associated with another color plane.

For a reference picture, motion prediction models such as an affine motion model can be described explicitly (e.g., by signaling MVs at control points of a current block) or implicitly (e.g., by deriving MVs at the control points of the current block from spatial neighboring motion models, or by using neighboring blocks' MVs as the control points' MVs for the current block). When multiple reference pictures are used in a motion prediction model, such as an affine motion model, a motion prediction model of one of the multiple reference pictures can be derived from another motion prediction model of another of the multiple reference pictures, for example, to improve efficiency of the motion prediction model.

According to some embodiments, multiple reference pictures can be used to predict samples in a current block of a current picture based on a motion prediction mode. The multiple reference pictures can include a first reference picture and a second reference picture in a video sequence that further includes the current picture. First MV prediction information for the first reference picture can be obtained either explicitly from signals in a video bitstream or implicitly from, for example, neighboring blocks of the current block. Second MV prediction information for the second reference picture can be determined based on the first MV prediction information and temporal relationships among the first reference picture, the second reference picture, and the current picture in the video sequence. Subsequently, a sample in the current block can be reconstructed based on a first sample in the first reference picture and a second sample in the second reference picture where a first position of the first sample is determined based on the first MV prediction information, and a second position of the second sample is determined based on the second MV prediction information. In an example, a predicted value (or a predictor) for the sample in the current block can be determined based on a function of a first predicted value (or a first predictor) of the first sample and a second predicted value (or a second predictor) of the second sample. The function can be a weighted average of the first predicted value and the second predicted value.

The motion prediction model can be any suitable motion prediction model, such as an affine motion mode. In general, an affine motion model can describe a motion or a combination of motions of an object, such as zooming (or scaling), rotation, translation, and/or deformation of the object. The motion or the combination of motions can propagate in a time domain, and thus, can be manifested in the multiple reference pictures that correspond to different times. Accordingly, an affine motion model in one reference picture can be predicted from another affine motion model in another reference picture. The description below is mainly for the affine motion mode, however, the description can be suitably adapted to other motion prediction modes.

In the present disclosure, the term “in the past” relative to the current picture indicates that a reference picture has a picture order count (POC) smaller than a current POC of the current picture, or the reference picture is displayed prior to the current picture in a display order. Similarly, in the present disclosure, the term “in the future” relative to the current picture indicates that the reference picture has a POC larger than the current POC, or the reference picture is displayed after the current picture in the display order.

The first reference picture, the second reference picture, and the current block can have any suitable temporal relationships in the video sequence, such as shown in four different embodiments below. In a first embodiment, the first and the second reference pictures are one before or after the current picture (or on a same side of the current picture) in the video sequence, that is, a first POC of the first reference picture and a second POC of the second reference picture are larger or smaller than the current POC. Accordingly, in an example, the first and the second reference pictures can be in the past and displayed prior to the current picture. In another example, the first and the second reference pictures can be in the future and displayed after the current picture. An extrapolation method can be used to generate second MV prediction information based on the first MV prediction information.

Alternatively, in a second, a third, and a fourth embodiment, the first and the second reference pictures are on opposite sides of the current picture in the video sequence, that is, one of the first POC and the second POC is larger than the current POC, and another of the first POC and the second POC is smaller than the current POC. Accordingly, one of the first and the second reference pictures is in the past and displayed prior to the current picture, and another of the first and the second reference pictures is in the future and displayed after the current picture. In some examples, the first POC is equal to the second POC, and the first and the second reference pictures are “mirror pictures” with respect to the current picture.

As described above, the second MV prediction information for the second reference picture can be determined based on the first MV prediction information and the temporal relationships among the first reference picture, the second reference picture, and the current picture in the video sequence, such as shown below using a 4-parameter affine motion model. The embodiments of the present disclosure can be extended to other motion prediction models including affine motion models with different numbers of parameters.

Eq. 1 (below) provides an example of a first 4-parameter affine motion model (or a first affine model) of the first reference picture where the first MV prediction information includes first affine parameters. The first affine parameters may include a first scaling factor ρ for zooming, a first angular factor θ for rotation, and a first translation MV, (c, f), to describe translation with respect to the first reference picture. Eq. 2 (below) provides an example of a second 4-parameter affine motion model (or a second affine model) of the second reference picture where the second MV prediction information includes second affine parameters. The second affine parameters may include a second scaling factor ρ′ for zooming, a second angular factor θ′ for rotation, and a second translation MV, (c′, f), to describe translation with respect to the second reference picture. A position (x, y) represents a sample location in the current picture, a first position (x′, y′) represents a corresponding first sample location in the first reference picture, and a second position (x″, y″) represents a corresponding second sample location in the second reference picture. For purposes of clarity, the rotation and the zooming over time are smooth (i.e., linear with respect to a temporal distance).

$$\begin{matrix}\{ \begin{matrix}{x}^{′} = ρ cos θ \cdot x + ρ sin θ \cdot y + c \\ {y}^{′} = - ρ sin θ \cdot x + ρ cos θ \cdot y + f\end{matrix} & ( 1 ) \\ \{ \begin{matrix}{x}^{″} = {ρ}^{′} cos {θ}^{′} \cdot x + {ρ}^{′} sin {θ}^{′} \cdot y + {c}^{′} \\ {y}^{″} = - {ρ }^{′} sin {θ}^{′} \cdot x + {ρ}^{′} cos {θ}^{′} \cdot y + {f}^{′}\end{matrix} & ( 2 )\end{matrix}$$

When the first affine parameters for the first reference picture are obtained, the second affine parameters can be determined (or derived) based on the first affine parameters and temporal relationships among the first reference picture, the second reference picture, and the current picture. In some examples, the temporal relationship can include a first temporal distance d0 of the current picture from the first reference picture and a second temporal distance d1 of the current picture from the second reference picture, as described below.

The first affine parameters for the first reference picture can be obtained based on two MVs at two control points of the current block with respect to the first reference picture either in the merge mode or in the residue mode. When the first affine parameters are obtained, for the sample at the position (x, y) in the current block, the first position (x′, y′) of the first sample in the first reference picture can be obtained, for example, using Eq. (1). Subsequently, a first MV pointing to the first reference picture can be determined as (x′-x, y′-y).

The second affine parameters for the second reference picture can be derived from the first affine parameters. When the second affine parameters are obtained, for the sample at the position (x, y) in the current block, the second position (x″, y″) of the second sample in the second reference picture can be obtained, for example, using Eq. (2). Subsequently, a second MV pointing to the second reference picture can be determined as (x″-x, y″-y).

Subsequently, a first predictor of the first sample and a second predictor of the second sample for the sample at the position (x, y) in the current block can be obtained, and a weighted average of the first and the second predictors can be used as a predictor for the sample at the position (x, y) in the current block.

As described above, in the first embodiment, the first and the second pictures are in the past or in the future, and the first and the second reference pictures can be from a same reference picture list, such as L1 or L0. The temporal relationships can include the first temporal distance d0 and a second temporal distance d1. In an example, the first temporal distance d0 is determined based on a difference between the first POC and the current POC, and the second temporal distance d1 is determined based on a difference between the second POC and the current POC.

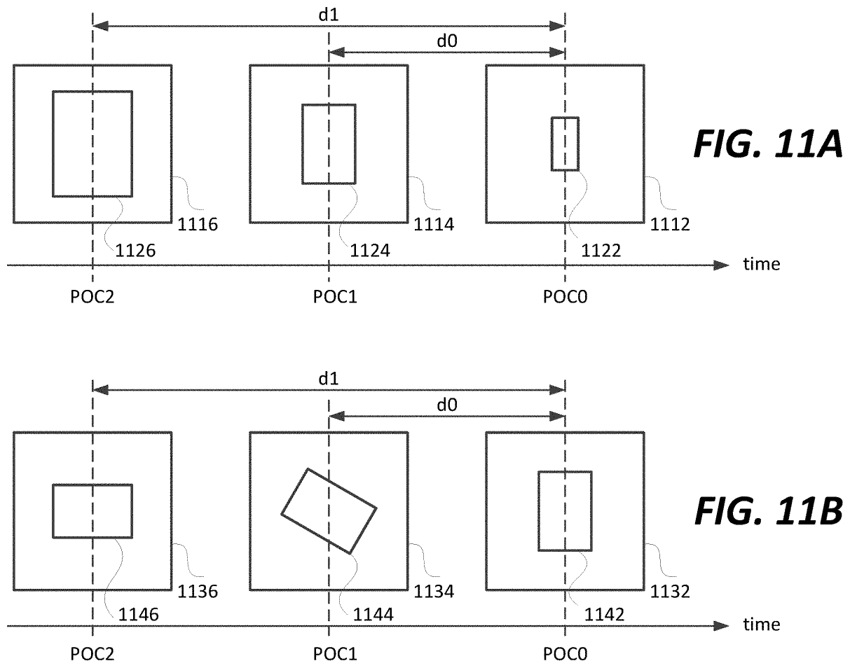

FIGS. 11A-11B show two examples of the first embodiment where a first POC and a second POC are smaller than a current POC of a current picture. In addition, a first temporal distance d0 is smaller than a second temporal distance d1. The first embodiment can also be implemented for examples where the first and the second POCs are larger than the current POC number, and/or d0 is larger than d1. FIG. 11A shows a propagation of zooming (or scaling) in the time domain. The first and the second reference pictures (1114) and (1116), respectively, are in the past relative to the current picture (1112), and the first POC (i.e., POC1), and the second POC (i.e., POC2), of the first and the second reference pictures (1114) and (1116), respectively, are smaller than the current POC (i.e., POCO), of the current picture (1112). An object (1126) in the second reference picture (1116) is zoomed out to an object (1124) in the first reference picture (1114), and is further zoomed out to an object (1122) in the current picture (1112) with time.

FIG. 11B shows a propagation of rotation in the time domain. The first and the second reference pictures (1134) and (1136) are in the past relative to the current picture (1132). The first and second POCs and the first and the second temporal distances are similar to those described above, thus, a detailed description is omitted for purposes of clarity. An object (1146) in the second reference picture (1136) rotates clockwise to become an object (1144) in the first reference picture (1134), and further rotates clockwise to become an object (1142) in the current picture (1132) with time.

In the following description, examples of determining the second MV prediction information for the second reference picture (i) using an extrapolation method and (ii) based on the first MV prediction information and the first and second temporal distances are shown.

In an example, when there is no rotation in the first and the second affine motion models, Eqs. (1) and (2) can be simplified as shown in the following Eqs. (3) and (4):

$$\begin{matrix}\{ \begin{matrix}{x}^{′} = ρ \cdot x + c \\ {y}^{′} = ρ \cdot y + f\end{matrix} & ( 3 ) \\ \{ \begin{matrix}{x}^{″} = {ρ}^{′} x + {c}^{′} \\ {y}^{″} = {ρ}^{′} y + {f}^{′}\end{matrix} & ( 4 )\end{matrix}$$

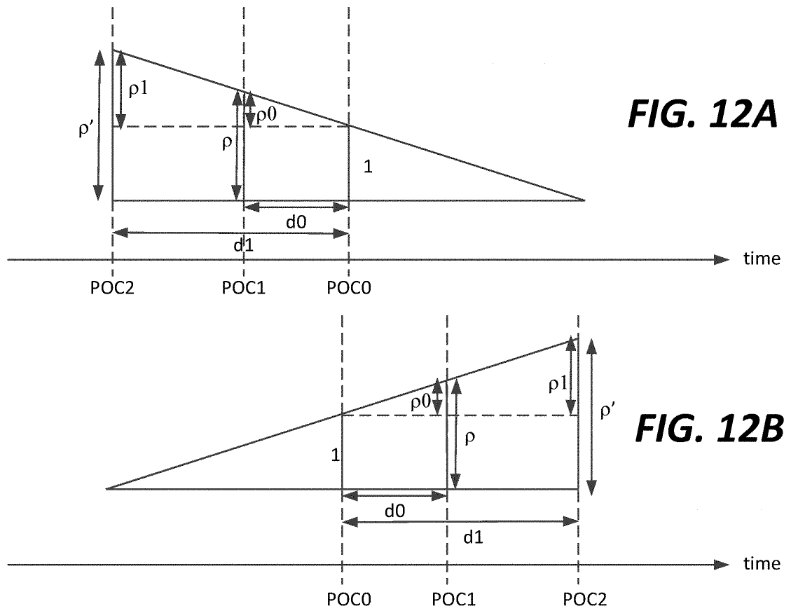

FIGS. 12A-12B show examples corresponding to linear scaling. FIG. 12A shows an example of zooming out with time. FIG. 12B shows an example of zooming in with time. A current POC (i.e., POC0), a first POC (i.e., POC1), and a second POC (i.e., POC2) of a current picture, a first reference picture, and a second reference picture, respectively, are also shown. Let p=(1+ρ0), ρ′=(1+ρ1), where ρ0 and ρ1 are relative scaling factors associated with the first and the second reference pictures, respectively, and are positive in the FIGS. 12A-12B examples. For example, there is no zooming between the current picture and the first reference picture when p0 is 0, and there is no zooming between the current picture and the second reference picture when ρ1 is 0. We have the following equation:

$$\frac{ρ 0}{ρ 1} = \frac{d 0}{d 1} \qquad ( 5 )$$

Accordingly, ρ′ can be obtained from p based on Eq. (5), and p′=1+(ρ−1) d₁/d₀. For exponential scaling, ρ′=ρ^{N1} where N1 is a parameter based on the exponential scaling.

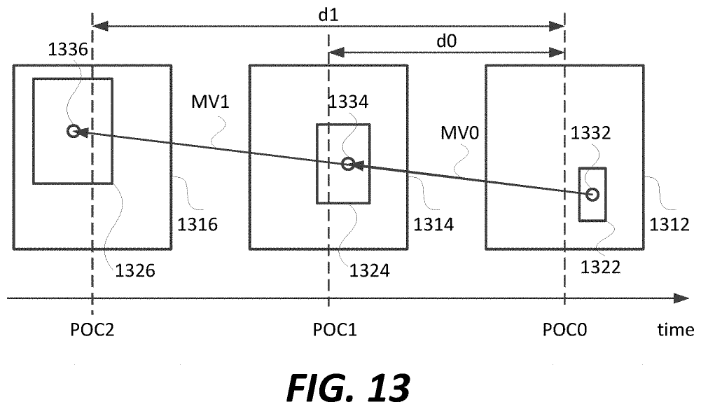

FIG. 13 shows an example corresponding to translation (or translation motion). A sample (1332) at a center of a current block (1322) in a current picture (1312) may be chosen as an origin of an affine motion model. Therefore a motion of the sample (1332) may be limited to the translation. A first translation MV may be MV0 from the sample (1332) to a sample (1334) in a first block (1324) of a first reference picture (1314), thus, MV=(c, f). Similarly, a second translation MV may be MV1 from the sample (1332) to a sample (1336) in a second block (1326) of a second reference picture (1316), thus, MV1=(c′, f). Referring to FIG. 13, MV pairs (i.e., MV0 and MV1), have a same direction and are proportional where MV1=N₂ MV0 and N₂ is a ratio of d1 over d0 (N₂=d1/d0). As described above, the MV pairs satisfy the following equation:

(c′, f′)=(N₂c, N₂f) (6)

When the affine motion model is limited to the linear scaling and the translation, Eq. (4) can be written as:

$$\{ \begin{matrix}{x}^{″} = [ {N}_{2} ( ρ - 1 ) + 1 ] x + {N}_{2} c \\ {y}^{″} = [ {N}_{2} ( ρ - 1 ) + 1 ] y + {N}_{2} f\end{matrix} \qquad ( 7 )$$

When the affine motion model is limited to the exponential scaling and the translation, Eq. (4) can be written as:

$$\{ \begin{matrix}{x}^{″} = {ρ}^{{N}_{1}} x + {N}_{2} c \\ {y}^{″} = {ρ}^{{N}_{1}} y + {N}_{2} f\end{matrix} \qquad ( 8 )$$

As described above, the second affine parameters ρ′ and (c′, f′) are derived from the first affine parameters ρ and (c, f) respectively based on the affine motion model limited to the scaling and the translation and the temporal relationships including the first temporal distance d0 and the second temporal distance d1. In an example, the temporal relationships can also be the ratio N2 of the second temporal distance d1 over the first temporal distance d0. Further, the second affine parameters ρ′ and (c′, f′) change when the affine motion model changes, for example, from the linear scaling to the exponential scaling or vice versa.

The above descriptions associated with the Eqs. (3)-(8) is given when the first and the second affine motion models do not include the rotation, however, the description can be adapted to include the rotation.

Two methods for the first embodiment are described below. In a first method of the first embodiment, a residue mode is used. Certain prediction information including a prediction flag and an affine enabled flag (or an affine flag) can be explicitly signaled. The prediction flag indicating a prediction direction (e.g., L0, L1, or bi-prediction) can be signaled before related syntax elements for the residue mode and/or the motion prediction mode. Secondly, without restriction to an order after the prediction flag, the affine flag can be signaled to indicating an affine motion model. When the prediction flag indicating the bi-prediction and the affine flag are signaled for the current block, first affine MV prediction information for a first reference picture can be signaled. In an example when the first MV prediction information includes (i) MV predictors and residual MV components at respective control points of the current block and (ii) a first reference index for the first reference picture in a first reference picture list (e.g., L0), the first parameters can be obtained from the MV predictors and the residual MV components. In another example, the first MV prediction information includes the first affine parameters.

An extrapolation flag, such as an extrapolate_affine_flag, can be used to indicate extrapolation of second MV prediction information from the first MV prediction information. In an example, when a second reference picture list (e.g., L1) does not include a reference picture that is different from the first reference picture and is on a same side of the current picture as the first reference picture, the extrapolation flag is not signaled and is inferred to be false. When the extrapolation flag is signaled, the second MV prediction information, for example, including the second affine parameters is not signaled but can be derived based on the first MV prediction information, as described above. In an example, a second reference index identifying the second reference picture in the second reference picture list (e.g., L1) can be signaled. In another example, the second reference index is not signaled. Instead, a reference picture in L1 with a smallest POC difference from the current picture is selected to be the second reference picture, and an index of the reference picture is the second reference index.

A multiple hypothesis can be used where a motion compensation for the current block can use multiple reference pictures. In a second method of the first embodiment, the multiple reference pictures further include an additional reference picture. The first and the second reference pictures and the additional reference picture are before or after the current picture in the video sequence. Additional MV prediction information for the additional reference picture can be determined based on the first MV prediction information, the first temporal distance, and an additional temporal distance of the current picture from the additional reference picture. Subsequently, the sample in the current block can be reconstructed further based on an additional sample in the additional reference picture where a position of the additional sample being determined based on the additional MV prediction information.

As described above, in the second embodiment, a first and a second reference pictures are on opposite sides of a current picture in a video sequence. Accordingly, one of the first and the second reference pictures is in the past and displayed prior to the current picture, and another of the first and the second reference pictures is in the future and displayed after the current picture. In an example, a first temporal distance d0 is equal to a second temporal distance d1, and the first and the second reference pictures are a pair of mirror pictures with respect to the current picture. In another example, the first temporal distance d0 is not equal to the second temporal distance d1, however, the second MV prediction information is derived from the first MV prediction information by setting d1 to be d0.

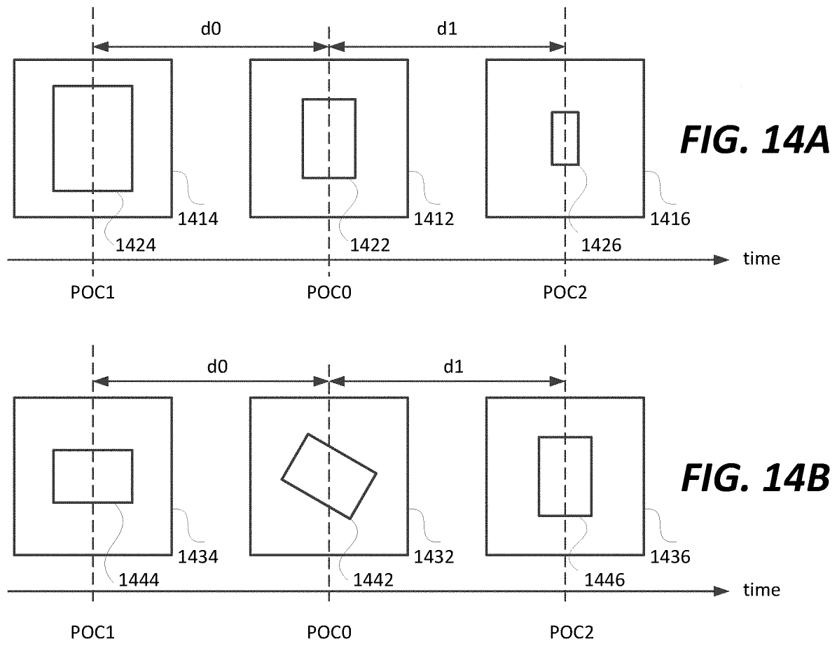

FIGS. 14A-14B show two examples of the second embodiment where a first POC is smaller than a current POC of a current picture, and a second POC is larger than the current POC of the current picture. The second embodiment can be suitably adapted for examples where the first POC is larger than the current POC, and the second POC is smaller than the current POC. FIG. 14A shows a propagation of zooming in the time domain. The first and the second reference pictures (1414) and (1416) are on opposite sides relative to the current picture (1412) where the first POC (i.e., POC1), is smaller than the current POC (i.e., POC0), and the second POC (i.e., POC2), is larger than POC0. In an example, a first temporal distance d0 is equal to a second temporal distance d1. An object (1424) in the first reference picture (1414) is zoomed out to an object (1422) in the current picture (1412), and is further zoomed out to an object (1426) in the second picture (1416) with time.

FIG. 14B shows a propagation of rotation in the time domain. Similar to FIG. 14A, a first and a second reference picture (1434) and (1436) are on opposite sides relative to a current picture (1432). A first and a second POC and a first and a second temporal distance are similar to those described above, thus, a detailed description is omitted for purposes of clarity. An object (1444) in the first reference picture (1434) rotates clockwise to become an object (1442) in the current picture (1432), and further rotates clockwise to become an object (1446) in the second picture (1436) with time.

As described above, second MV prediction information for the second reference picture can be determined based on first MV prediction information using a 4-parameter affine motion model. Methods in the present disclosure can be extended to other motion models including affine motion models with different numbers of parameters. A first affine motion model of the first reference picture and a second affine motion model of the second reference picture can be described by Eqs (1) and (2), respectively.

In an example, the first POC is equal to the second POC where the first and the second reference pictures are a pair of “mirror pictures” with respect to the current picture, thus, the first temporal distance d0 is equal to the second temporal distance d1 in FIGS. 14A-14B. Therefore, Eq. (2) for the second affine model becomes:

$$\{ \begin{matrix}{x}^{″} = {ρ}^{′} cos θ \cdot x - {ρ}^{′} sin θ \cdot y - c \\ {y}^{″} = {ρ }^{′} sin θ \cdot x + {ρ}^{′} cos θ \cdot y - f\end{matrix} \qquad ( 9 )$$

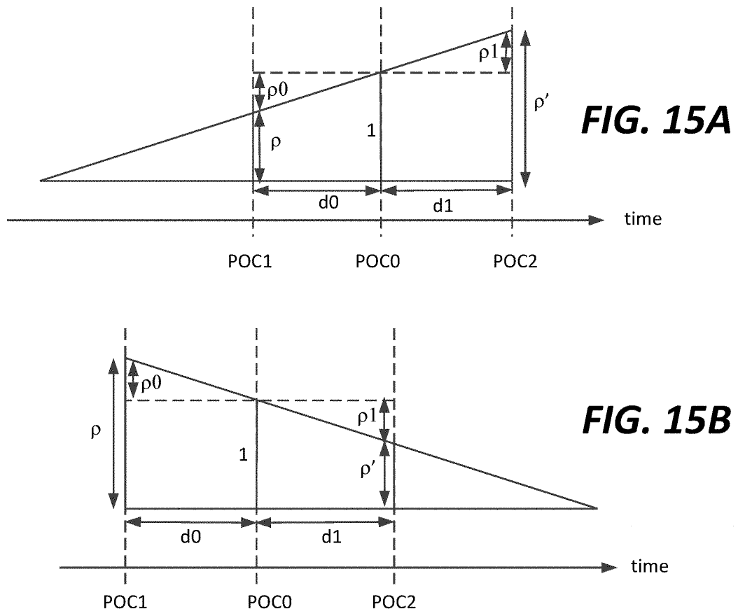

FIGS. 15A-15B show examples corresponding to linear scaling. Similar to FIGS. 12A-12B, FIG. 15A shows an example of zooming in with time. FIG. 15B shows an example of zooming out with time. A current POC (POC0), a first POC (POC1), and a second POC (POC2) of a current picture, a first reference picture, and a second reference picture, respectively, are also shown. Let p=(1+ρ0), p′=(1+ρ1), then ρ0 is negative and pl is positive in FIG. 15A, and ρ0 is positive and ρ1 is negative in FIG. 15B. We have the following equation:

ρ0/ρ1=−d0/d1 (10)

where a first temporal distance is d0 and a second temporal distance is dl. Further, when the first temporal distance d0 is equal to the second temporal distance d1, ρ′=2−ρ.

When the scaling is exponential and the first temporal distance d0 is equal to the second temporal distance d1, ρ′=1/ρ.

Two methods for the second embodiment are described below. In a first method of the second embodiment, a residue mode is used. Similar to the first method of the first embodiment, certain prediction information including the prediction flag and the affine flag can be explicitly signaled. When the prediction flag indicating the bi-prediction and the affine flag are signaled for a current block, availability of a pair of mirror pictures in a first reference picture list and a second reference picture list is determined. When a pair of mirror pictures is available, a mirror flag, e.g., a mirror_affine_flag, can be used to indicate an affine motion model with a pair of mirror pictures. When no mirror pictures are available, the mirror flag is not signaled, but inferred to be false. In an example, when the mirror flag is signaled, reference picture indices for the pair of mirror pictures are not signaled. When there is more than one pair of mirror pictures, the pair of mirror pictures with a smallest first or second temporal distance d0 or d1 is selected. The smallest first temporal distance d0 can correspond to a minimal POC difference between the first reference picture and the current picture. In an example, when a pair of mirror pictures is available, the mirror flag is not signaled but inferred to be true.

Further, when the pair of mirror pictures is available, first affine MV prediction information for the first reference picture can be signaled where the first reference picture is one of the pair of mirror pictures. In an example, the first affine MV prediction information includes first affine parameters. In another example, the first affine MV prediction information includes MV predictors and residual MV components at respective control points of the current block. Subsequently, second affine MV prediction information of the other one of the pair of mirror pictures can be derived based on the first affine MV prediction and a ratio of d0/d1 being 1, as described above. The first reference picture can be indicated in the first reference picture list (e.g., L0), and the other one of the pair of mirror pictures can be indicated in the second reference picture list. Conversely, the first reference picture can be indicated in the second reference picture list, and the other one of the pair of mirror pictures can be indicated in the first reference picture list.

An example syntax table is provided in Table 1 below where portions highlighted using italics and bold texts show examples of the first method of the second embodiment described above.

TABLE 1
Example syntax table

| | |
|---|---|
| If(merge_flag) | |
| { | |
| ...... | |
| } | |
| else { | |
| if( slice_type = = B) | |
| inter_pred_idc[ x0 ][ y0 ] | ae(v) |
| affine_flag | ae(v) |
| if( inter_pred_idc[ x0 ][ y0 ] == PRED_BI && affine_flag | |
| && there is a mirrored pair of reference pictures available) | |
| [symbol] _ [symbol] _ [symbol] | ae(v) |
| if( inter_pred_idc[ x0 ][ y0 ] != PRED_L1 ) { | |
| if( num_ref_idx_l0_active_minus1 > 0 ) | |
| if( !mirror_affine_flag ) | |
| ref_idx_l0[ x0 ][ y0 ] | ae(v) |
| mvd_coding( x0, y0, 0 ) | |
| if ( affine_flag ) | |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 | |
| && !mirror_affine_flag) { | |
| if( num_ref_idx_l1_active_minus1 > 0 ) | |
| ref_idx_l1[ x0 ][ y0 ] | ae(v) |
| mvd_coding( x0, y0, 1 ) | |
| if ( affine_flag ) | |
| mvd_coding( x0, y0, 1 ) | |
| mvp_l1_flag[ x0 ][ y0 ] | ae(v) |
| } | |
| } | |
| } | |

In a second method of the second embodiment, the first temporal distance d0 and the second temporal distance d1 can be different. The first MV prediction information of the first reference picture can be signaled while the second MV prediction information of the second reference picture can be determined (or derived) based on the first MV prediction information, for example, using Eqs. (1) and (9), by setting the second temporal distance d1 to be the first temporal distance d0. For example, even when the first temporal distance d0 and the second temporal distance d1 are different and the ratio of d0/d1 is not 1, the second translation MV (c′, f) is set to be (−c, −f), and ρ′=2−ρ for the linear scaling or p′=1/ρ for the exponential scaling.

The second method of the second embodiment can be implemented in a residue mode, similar to that described in the first method of the second embodiment, thus, detailed description is omitted for purposes of clarity. A first reference index indicating the first reference picture in the first reference picture list (e.g., L0) may be signaled. Further, the first MV prediction information of the first reference picture may be signaled. When the mirror flag is true, a second reference index indicating the second reference picture in the second reference picture list can be signaled or inferred. When inferred, the second reference index can point to the second reference picture having a smallest temporal distance d1 in the second reference picture list. Alternatively, the second reference index can point to the second reference picture having the second temporal distance d1 as close as possible to the first temporal distance d0.

An example syntax table is provided in Table 2 below where portions highlighted using italics and bold texts show examples of the second method of the second embodiment described above.

TABLE 2
Example syntax table

| | |
|---|---|
| If(merge_flag) | |
| { | |
| ...... | |
| } | |
| else { | |
| if( slice_type = = B) | |
| inter_pred_idc[ x0 ][ y0 ] | ae(v) |
| affine_flag | ae(v) |
| if( inter_pred_idc[ x0 ][ y0 ] == PRED_BI && affine_flag ) | |
| [symbol] _ [symbol] _ [symbol] | ae(v) |
| if( inter_pred idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| if ( affine_flag ) | |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 && | |
| !mirror_affine_flag) { | |
| if( num_ref_idx_l1_active_minus1 > 0 ) | |
| ref_idx_l1[ x0 ][ y0 ] | ae(v) |
| mvd_coding( x0, y0, 1 ) | |
| if ( affine_flag ) | |
| mvd_coding( x0, y0, 1 ) | |
| mvp_l1_flag[ x0 ][ y0 ] | ae(v) |
| } | |
| } | |
| } | |

As described above, in the third embodiment, a first and a second reference pictures are on opposite sides of a current picture in a video sequence. Accordingly, one of the first and the second reference pictures is in the past and displayed prior to the current picture, and another of the first and the second reference pictures is in the future and displayed after the current picture. In an example, a first temporal distance d0 is equal to a second temporal distance dl, and the first and the second reference pictures are a pair of mirror pictures with respect to the current picture. Further, a motion prediction mode can be an affine prediction model limited to rotation and translation.

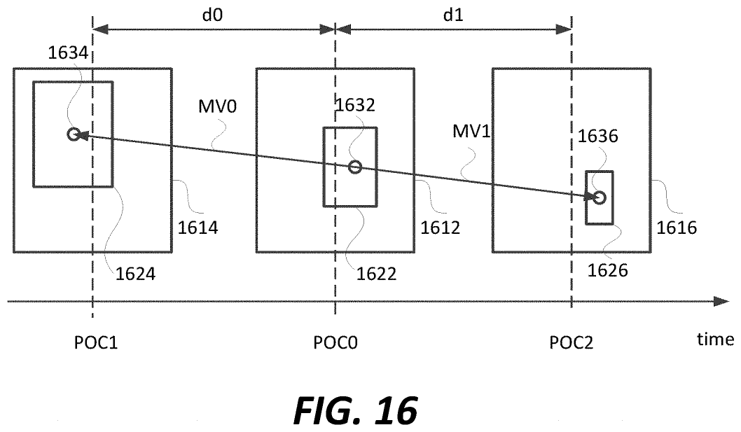

FIG. 16 shows an example corresponding to translation when a first reference picture and a second reference picture are on opposite sides of a current picture. A sample (1632) at a center of a current block (1622) in a current picture (1612) is chosen as an origin of an affine motion model, thus, a motion of the sample (1632) is limited to the translation. A first translation MV is a MV0 from the sample (1632) to a sample (1634) in a first block (1624) of a first reference picture (1614), thus, MV0=(c, f). Similarly, a second translation MV is a MV1 from the sample (1632) to a sample (1636) in a second block (1626) of a second reference picture (1616), thus, MV1=(c′, f). Referring to FIG. 16, MV pairs (i.e., MV0 and MV1), have opposite directions and are proportional where MV1=−N2 MV0 and N2 is a ratio of a second temporal distance d1 over a first temporal distance d0 (N2=d1/d0). When the first and the second reference pictures are mirror pictures, i.e., the first temporal distance is equal to the second temporal distance (d0=d1 and N2=1), and MV1=−MV0=−(c, f).

When the affine motion model is limited to the rotation and the translation, the 4-parameter affine motion mode described by Eqs. (1) and (2) become:

$$\begin{matrix}\{ \begin{matrix}{x}^{′} = cos θ \cdot x + sin θ \cdot y + c \\ {y}^{′} = - sin θ \cdot x + cos θ \cdot y + f\end{matrix} & ( 11 ) \\ \{ \begin{matrix}{x}^{″} = cos {N}_{2} θ \cdot x - sin {N}_{2} θ \cdot y - c \\ {y}^{″} = sin {N}_{2} θ \cdot x + cos {N}_{2} θ \cdot y - f\end{matrix} & ( 12 )\end{matrix}$$

As seen in Eqs. (11) and (12), the 4-parameters are reduced to 3 parameters when the affine motion model is limited to the rotation and translation. More specifically, the first affine parameters include the first angular factor 0 for the rotation, and the first translation MV, (c, f), for the translation. The second affine parameters include the second angular factor θ′ for the rotation, and the second translation MV, (c′, f′), for the translation. The second affine parameters can be derived based on the first affine parameters using θ′=−N₂θ, and (c′, f′)=−N₂ (c, f), and the ratio N₂ is determined based on the first and the second temporal distances d0 and d1, respectively. In an example, when the first and the second reference pictures are mirror pictures, i.e., the first temporal distance is equal to the second temporal distance (d0=d1), and thus, θ′=−θ, and (c′, f)=−(c, f).

In the third embodiment, a residue mode can be used. Similar to the first method of the first embodiment, certain motion information including the prediction flag and the affine flag can be explicitly signaled. When the prediction flag indicating the bi-prediction and the affine flag are true, a rotation flag, e.g., a derived_rotation_affine_flag can be signaled to indicate that the affine prediction model is limited to the rotation and the translation. In an example, when the first and the second reference pictures are required to be a pair of mirror ictures, availability of a pair of mirror pictures in a first reference picture list and a second reference picture list is determined. When no mirror pictures are available, the rotation flag is not signaled, but inferred to be false. When at least a pair of mirror pictures is available, the rotation flag can be signaled. Alternatively, the rotation flag is not signaled, but can be inferred to be true. Further, when at least the pair of mirror pictures is available, a pair of mirror pictures having a smallest temporal distance d0 (or d1) is selected to be the first and the second reference pictures.

In another example, when the first and the second reference pictures are not required to be a pair of mirror pictures, at least one of the first and the second reference pictures is chosen. For example, a reference picture index for one of the first and the second reference pictures is signaled. For purposes of clarity, the description below shows an example where a first index for the first reference picture in the first reference picture list (e.g., L0) is signaled. The description can be suitably adapted to cases where a second index for the second reference picture is signaled. When the first index for the first reference picture in the first reference picture list is signaled, the second reference picture in the second reference picture list can be determined to be a reference picture having a smallest temporal distance d1 or a reference picture having a temporal distance d1 where an absolute value of a difference between the first temporal distance d0 and the second temporal distance d1 is minimal. Alternatively, a second reference picture index is signaled to indicate the second reference picture in the second reference picture list.

Further, when the rotation flag is true, first affine MV prediction information for the first reference picture can be signaled. The first affine MV prediction information can include the first affine parameters, e.g., the first angular factor θ for the rotation and the first translation MV, (c, f) for the translation. In an example, the first affine parameters can be coded predicatively, and thus, only residues of the first affine parameters are signaled.

Subsequently, second affine MV prediction information of the second reference picture can be derived based on the first affine MV prediction, as described above. In an example, the ratio N₂ of d0/d1 is set to 1.

An example syntax table is provided in Table 3 below where portions highlighted using italics and bold texts show examples of the third embodiment described above.

TABLE 3
Example syntax table

| | |
|---|---|
| If(merge_flag) | |
| { | |
| ...... | |
| } | |
| else { | |
| if( slice_type = = B) | |
| inter_pred_idc[ x0 ][ y0 ] | ae(v) |
| affine_flag | ae(v) |
| if( affine_flag) | |
| scaling_flag | ae(v) |
| if( affine_flag && !scaling_flag) | |
| rotation_flag | ae(v) |
| if( inter pred idc[ x0 ][ y0 ] = = PRED BI && rotation_flag | |
| && there is a mirrored pair of reference pictures available) | |
| [symbol] _ [symbol] _ [symbol] _ [symbol] | ae(v) |
| if( inter_pred_idc[ x0 ][ y0 ] != PRED_L1 ) { | |
| if( num_ref_idx_l0_active_minus1 > 0 ) | |
| if( !derived_rotation_affine_flag ) | |
| ref_idx_l0[ x0 ][ y0 ] | ae(v) |
| mvd_coding( x0, y0, 0 ) | |
| if( affine_flag && !scaling_flag && !rotation_flag) | |
| mvd coding( x0, y0, 0 ) | |
| else if (scaling_flag \|\| rotation_flag) | |
| affine_rotation_or_scaling_factor | ae(v) |
| mvp_l0_flag[ x0 ][ y0 ] | ae(v) |
| } | |
| if( inter_pred_idc[ x0 ][ y0 ] != PRED_L0 | |
| && !derived_rotation_affine_flag) { | |
| if( num_ref_idx_l1_active_minus1 > 0 ) | |
| ref_idx_l1[ x0 ][ y0 ] | ae(v) |
| mvd_coding( x0, y0, 1 ) | |
| if( affine_flag && !scaling_flag && !rotation_flag) | |
| mvd_coding( x0, y0, 1 ) | |
| else if (scaling_flag \|\| rotation_flag) | |
| affine_rotation_or_scaling_factor | ae(v) |
| mvp_l1_flag[ x0 ][ y0 ] | ae(v) |
| } | |
| } | |
| } | |

The fourth embodiment is similar to the third embodiment except that the affine motion model is limited to the zooming (instead of the rotation) and the translation, the 4-parameter affine prediction mode described by Eqs. (1) and (2) become:

$$\begin{matrix}\{ \begin{matrix}{x}^{′} = ρ x + c \\ {y}^{′} = ρ y + f\end{matrix} & ( 13 ) \\ \{ \begin{matrix}{x}^{″} = {ρ}^{′} x - {N}_{2} c \\ {y}^{″} = {ρ}^{′} y - {N}_{2} f\end{matrix} & ( 14 )\end{matrix}$$

As seen in Eqs. (13) and (14), the 4-parameters are also reduced to 3 parameters when the affine motion model is limited to the zooming and the translation. More specifically, the first affine parameters include the first scaling factor p for the zooming, and the first translation MV, (c, f), for the translation. The second affine parameters include the second scaling factor ρ′ for the scaling, and the second translation MV, (c′, f′) for the translation. The second translation MV, (c′, f′) for the translation can be derived based on the first translation MV using (c′, f′)=−N₂ (c, f), and the ratio N₂ is determined based on the first and the second temporal distances d0 and d1, respectively. Further, the second scaling factor ρ′ can be derived from the first scaling factor ρ as described above.

Referring to FIGS. 15A-15B, ρ=(1+ρ0), ρ′=(1+ρ1), and

$$\frac{ρ 1}{ρ 0} = - \frac{d 1}{d 0} = - {N}_{2} \cdot ρ 0$$

is negative, and ρ1 is positive in FIG. 15A, and ρ0 is positive, and ρ1 is negative in FIG. 15B. Therefore, Eqs. (13) and (14) become:

$$\begin{matrix}\{ \begin{matrix}{x}^{′} = ( 1 + ρ 0 ) \cdot x + c \\ {y}^{′} = ( 1 + ρ 0 ) \cdot y + f\end{matrix} & ( 15 ) \\ \{ \begin{matrix}{x}^{″} = ( 1 + ρ 1 ) \cdot x - {N}_{2} c \\ {y}^{″} = ( 1 + ρ 1 ) \cdot y - {N}_{2} f\end{matrix} & ( 16 )\end{matrix}$$

As described above, when the first temporal distance d0 is equal to the second temporal distance d1, we have ρ′=2−ρ for the linear scaling, and ρ′=1/ρ for the exponential scaling.

Similarly, a residue mode can be used in the fourth embodiment, and certain motion information including the prediction flag and the affine flag can be explicitly signaled. When the prediction flag indicating the bi-prediction and the affine flag are signaled for a current block, a scaling flag, e.g., a derived_scaling_affine_flag can be signaled to indicate that the affine prediction model is limited to the scaling and the translation. In an example, when the first and the second reference pictures are required to be a pair of mirror pictures, availability of a pair of mirror pictures in a first reference picture list and a second reference picture list is determined. When no mirror pictures are available, the scaling flag is not signaled, but inferred to be false. When at least a pair of mirror pictures is available, the scaling flag can be signaled. Alternatively, the scaling flag is not signaled, but inferred to be true. Further, when at least a pair of mirrored reference pictures is available, a pair of mirrored reference pictures having a smallest temporal distance d0 (or d1) may be selected to be the first and the second reference pictures.

In another example, when the first and the second reference pictures are not required to be a pair of mirror pictures, at least one of the first and the second reference pictures is chosen. For example, a reference picture index for one of the first and the second reference pictures is signaled. For purposes of clarity, the description below shows an example where a first index for the first reference picture in the first reference picture list (e.g., L0) is signaled. The description can be suitably adapted to cases where a second index for the second reference picture is signaled. When the first index for the first reference picture in the first reference picture list is signaled, the second reference picture in the second reference picture list can be determined to be a reference picture having a smallest temporal distance d1 or a reference picture having a temporal distance d1 where an absolute value of a difference between the first temporal distance d0 and the second temporal distance d1 is minimal. Alternatively, a second reference picture index is signaled to indicate the second reference picture in the second reference picture list.

Further, when the scaling flag is true, first affine MV prediction information for the first reference picture can be signaled. The first affine MV prediction information can include the first affine parameters, e.g., the first scaling factor p for the scaling and the first translation MV, (c, f) for the translation. In an example, the first affine parameters can be coded predicatively, and thus, only residues of the first affine parameters are signaled.

Subsequently, second affine MV prediction information of the second reference picture can be derived based on the first affine MV prediction, as described above. In an example, the ratio N2 of d0/d1 is set to 1.

An example syntax table is provided in Table 4 below where portions highlighted using italics and bold texts show examples of the fourth embodiment described above.

TABLE 4
Example syntax table

| | |
|---|---|
| If(merge_flag) | |
| { | |
| ...... | |
| } | |
| else { | |
| if( slice_type = = B) | |
| inter_pred_idc[ x0 ][ y0 ] | ae(v) |
| affine_flag | ae(v) |
| if( affine_flag) | |
| scaling_flag | ae(v) |
| if( affine_flag && !scaling_flag) | |
| rotation_flag | ae(v) |
| if( inter_pred_idc[ x0 ][ y0 ] = = PRED_BI && scaling_flag | |
| && there is a mirrored pair of reference pictures available) | |
| [symbol] _ [symbol] _ [symbol] _ [symbol] | ae(v) |
| if( inter_pred_idc[ x0 ][ y0 ] != PRED_L1 ) { | |
| if( num_ref_idx_l0_active_minus1 > 0 ) | |
| if( !derived_scaling_affine_flag ) | |
| ref_idx_l0[ x0 ][ y0 ] | ae(v) |
| mvd_coding( x0, y0, 0 ) | |
| if( affine_flag && !scaling_flag && !rotation_flag) | |
| mvd_coding( x0, y0, 0 ) | |
| else if (scaling_flag \|\| rotation_flag) | |
| affine_rotation_or_scaling_factor | ae(v) |
| mvp_l0_flag[ x0 ][ y0 ] | ae(v) |
| } | |
| if( inter_pred_idc[ x0 ][ y0 ] != PRED_L0 | |
| && !derived_scaling_affine_flag) { | |
| if( num_ref_idx_l1_active_minus1 > 0 ) | |
| ref_idx_l1[ x0 ][ y0 ] | ae(v) |
| mvd_coding( x0, y0, 1 ) | |
| if( affine_flag && !scaling_flag && !rotation_flag) | |
| mvd_coding( x0, y0, 1 ) | |
| else if (scaling_flag \|\| rotation_flag) | |
| affine_rotation_or_scaling_factor | ae(v) |
| mvp_l1_flag[ x0 ][ y0 ] | ae(v) |
| } | |
| } | |
| } | |

The first to the fourth embodiments described above can also be implemented in the merge mode, and the description above can be adapted accordingly. For example, residual MV components are assumed to be zero and are not signaled. In the merge mode, a merge candidate list can include certain merge candidates that are coded using an affine motion model. Affine parameters of the certain merge candidates can be from either previously coded affine blocks (model generated), or from using spatial neighboring blocks' MVs as the MVs at control points (corner generated). For a first candidate, for example, one of the certain merge candidates, of a first reference picture identified in a first reference picture list (e.g., L0), when a second reference picture identified in a second reference picture list (e.g., L1) is available for the current picture and certain conditions are satisfied, a second candidate for the second reference picture can be determined based on the first candidate. Further, a bi-prediction candidate that includes the first candidate and the second candidate is generated for the merge candidate list where the first MV prediction information corresponds to the first candidate and the second MV prediction information corresponds to the second candidate.

For the first embodiment, the certain conditions can specify that the first and the second reference pictures are in the past or in the future relative to the current picture. In an example, for each available reference picture in the second reference picture list, when the reference picture and the first reference picture are in the past or in the future relative to the current picture, a new bi-prediction candidate can be generated as described above. In another example, a reference picture (from the second reference picture list) that has a smallest temporal distance to the current picture is selected to be the second reference picture.

For the second embodiment, in an example, the certain conditions specify that the second reference picture and the first reference picture are mirror pictures. Alternatively, the certain conditions specify that the second reference picture has a smallest temporal distance from the current picture or a temporal distance that is as close as possible to the first temporal distance of the first reference picture. Further, the second candidate for the second reference picture can be determined based on the first candidate by setting a ratio of the second temporal distance over the first temporal distance to be 1 regardless of the second temporal distance.

For the third and the fourth embodiments, in an example, the certain conditions specify that the second reference picture and the first reference picture are mirror pictures. Alternatively, the certain conditions include that the second reference picture has a smallest temporal distance from the current picture.

For the first to the fourth embodiments, in an example, the merge candidate list can include bi-prediction merge candidates such as bi-prediction affine coded merge candidates. Each of the bi-prediction merge candidates can be regarded as two uni-directional prediction candidates where one of the two uni-directional prediction candidates is predicted from the first reference picture list (e.g., L0) and the other of the two uni-directional prediction candidates is predicted from the second reference picture list (e.g., L1). Each of the two uni-directional prediction candidates, when affine coded, can be used to generate a new bi-prediction candidate, as described above.

As described above, when an affine prediction mode is used to predict motion information for a current block, MVs for samples in the current block can be determined by an affine prediction model, such as a 6-parameter affine motion model, a 4-parameter affine motion model, or any other model with a desired number of parameters. In some embodiments, motions of different parts of the current block (for example, when the current block has a relatively large size) can be different, and thus, according to aspects of the present disclosure, the current block can be divided into multiple segments where each segment of the multiple segments can have an affine prediction model. Accordingly, motion information of samples in each segment can be generated by the respective affine prediction model. In an example, affine prediction models of the multiple segments are different. The current block can be divided into any suitable number of multiple segments having any suitable sizes. Further, the current block can be divided horizontally or vertically.

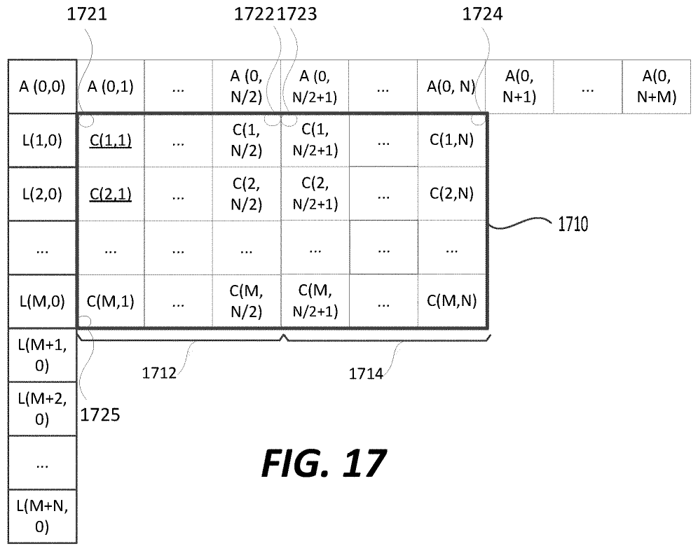

FIG. 17 shows an example of dividing a current block (1710) into multiple segments. The current block (1710) includes a plurality of sub-blocks C(1,1)-C(M,N) surrounded by neighboring blocks (or neighbors) A(0,0)-A(0,N+M) and L(1,0)-L(N+M,0). The neighbors A(0,0)-A(0,N+M) can be referred to as top neighbors of the current block (1710), and the neighbors L(1,0)-L(N+M, 0) can be referred to as left neighbors of the current block (1710). As described above, samples in each of the sub-blocks C(1,1)-C(M,N) have a same MV (i.e., the MV of the sub-block).

The current block (1710) is divided (or partitioned) horizontally into two segments (1712) and (1714). The segment (1712) is referred to as a left segment (1712), and the segment (1714) is referred to as a right segment (1714). In the FIG. 17 example, the partition is symmetric in a middle of a width of the current block (1710) and the two segments (1712) and (1714) have a same width (and a same height). Other partitions can be implemented. In another example, the current block (1710) can be divided asymmetrically into two segments having a width ratio of the two segments being 1:3 or 3:1. In another example, the current block (1710) can be divided symmetrically into three segments having a width ratio of the three segments being 1:2:1.

In order to generate MVs for sub-blocks in each segment of the current block (1710), MVs at control points (referred to as segment corners) of each segment are first determined. Description below is given for the FIG. 17 example where the current block (1710) is divided horizontally and symmetrically into the two segments (1712) and (1714). The description can be suitably adapted to other partitions. The following description is given for a residue mode, and can be suitably adapted to a merge mode.

When a 4-parameter affine prediction model is used, control points of the segment (1712) can be a top-left (1721) and a top-right corner (1722) of the segment (1712), respectively. In an example, each sub-block includes a plurality of samples, and thus, the top-left corner (1721) is a top-left sample in the sub-block C(1,1) and the top-right corner (1722) is a top-right sample in the sub-block C(1,N/2). To predict an MV predictor for the top-left corner (1721) of the segment (1712), similar MV predictor candidates for the top-left corner (1721) of the current block (1710) can be used. For example, MVs from the neighbors A(0,0), A(0,1), and L(1,0) in FIG. 17 can be MV predictor candidates for predicting the top-left corner (1721) of the segment (1712). Which of the MV predictor candidates to use in an actual MV predictor can be indicated by a MV predictor flag (a mvp_10_flag for a first reference picture list L0 or a mvp_11_flag for a second reference picture list L1).

A few examples are described below to predict an MV predictor for the top-right corner (1722) of the segment (1712). In an example, an MV of a top neighbor A(0, N/2) of the top-right corner (1722) can be used. In another example, an MV of a top-right neighbor A(0, N/2+1) of the top-right corner (1722) can be used. In another example, a weighted average of the MVs of the top neighbor A(0, N/2) and the top-right neighbor A(0, N/2+1) can be used. In another example, the MVs of the top neighbor A(0, N/2) and the top-right neighbor A(0, N/2+1) can be used as candidates.

Similarly, when the 4-parameter affine prediction model is used, control points of the segment (1714) can be a top-left (1723) and a top-right corner (1724) of the segment (1714), respectively. The top-left corner (1723) can be a top-left sample in the sub-block C(1, N/2+1) and the top-right corner (1724) is a top-right sample in the sub-block C(1,N). A few examples are described below to predict an MV predictor for the top left corner (1723) of the segment (1714). In an example, the MV of a top neighbor A(0, N/2+1) of the top-left corner (1723) can be used. In another example, the MV of a top-left neighbor A(0, N/2) of the top-left corner (1723) can be used. In another example, a weighted average of the MVs of the top neighbor A(0, N/2+1) and the top-left neighbor A(0, N/2) can be used. In another example, the MVs of the top neighbor A(0, N/2+1) and the top-left neighbor A(0, N/2) can be used as MV predictor candidates. To predict an MV predictor for the top right corner (1724) of the segment (1714), similar MV predictor candidates for the top-right corner (1724) of the current block (1710) can be used. For example, MVs from the neighbors A(0, N−1), A(0,N) and A(0,N+1) can be MV predictor candidates for predicting the top right corner (1724) of the segment (1714). Which of the MV predictor candidates to use in an actual MV predictor can be indicated by a MV predictor flag (e.g., a mvp_10_flag for a first reference picture list L0 or a mvp_11_flag for a second reference picture list L1).

In some embodiments, when a current block is divided into multiple segments, control points such as the control points (1721) and (1724) in FIG. 17 of the multiple segments that are also control points of the current block can be predicted using similar or identical candidates for the same control points of the current block.

In some embodiments, when a current block is divided into two horizontal segments, middle control points such as the control points (1722) and (1723) that are adjacent to another segment can be predicted as described below. In an example, an MV of a top-right corner of a left segment of the current block can be predicted from a top-right neighbor of the top-right corner of the left segment, and an MV of a top-left corner of a right segment of the current block can be predicted from a top-left neighbor of the top-left corner of the right segment. In another example, the MV of the top-right corner of the left segment of the current block can be predicted from a top neighbor of the top-right corner of the left segment, and the MV of the top-left corner of the right segment of the current block can be predicted from a top neighbor of the top-left corner of the right segment. In another example, the top-right corner of the left segment of the current block and the top-left corner of the right segment of the current block share motion information of a same control point, and the motion information of the shared control point can be the MV of the top neighbor or the MV of the top-right neighbor of the top-right corner of the left segment of the current block, or a weighted average of the above two MVs.

In some examples, when the MV of the neighbor A(0, N/2) and the MV of the neighbor A(0, N2+1) are used as MV predictor candidates for predicting a MV predictor for a control point, the MV of the neighbor A(0, N/2) and the MV of the neighbor A(0, N2+1) can be in different MV predictor candidate groups and can be selected by a MV predictor flag (a mvp_0_lag for the first reference picture list L0 or a mvp_1_lag for the second reference picture list L1).

In an embodiment, when a current block is divided horizontally into a left segment and a right segment of a same size, two control points and MV predictors for the left segment are from left neighbors of the current block. For example, two control points for the left segment (1712) can be the top-left corner (1721) and a bottom-left corner (1725), and MV predictors are from the left neighbors L(1,0) and L(M,0) of the current block (1710). On the other hand, two control points and MV predictors for the right segment are from top neighbors of the current block. For example, two control points for the right segment (1714) can be the top-left corner (1723) and the top-right corner (1724), and MV predictors are from the top neighbors A(0, N2+1) and A(0, N) of the current block (1710).

In another embodiment, when a current block is divided vertically into a top segment and a bottom segment, two control points and MV predictors for each of the top and bottom segment are from left neighbors of the current block.

In another embodiment, when a current block is divided vertically into a top segment and a bottom segment, two control points and MV predictors for the top segment are from top neighbors of the current block. Two control points and MV predictors for the bottom segment are from left neighbors of the current block.

Referring to FIG. 17, when the current block (1710) is divided horizontally into the two segments (1712) and (1714), the control points of the two segments (1712) and (1714) include the control points (1721) and (1724) that can also be the control points for the current block (1710), thus, residual MV components for the control points (1721) and (1724) can be signaled similar to what is used for the current block (1710).

On the other hand, the control points of the two segments (1712) and (1714) also include the middle control points, such as the top-right corner (1722) of the left segment (1712) and the top-left corner (1723) of the right segment (1714). Examples of signaling residual MV components for the middle control points (1722) and (1723) are shown below. In one embodiment, the middle control points (1722) and (1723) do not have residual MV components (or the residual MV components of the middle control points (1722) and (1723) are assumed to be zero), and thus, the residual MV components are not signaled and only the MV predictors are used. Accordingly, two instead of four residual MV components are signaled, thereby improving efficiency of the affine motion model. In another embodiment, the residual MV components of the middle control points (1722) and (1723) are also signaled. In yet another embodiment, as described above, the top-right corner (1722) of the left segment (1712) and the top-left corner (1723) of the right segment (1714) share the same motion information and MV predictor candidate of a same control point, thus, a residual MV component for the same MV predictor candidate is signaled. Accordingly, three instead of four residual MV components are signaled, thereby improving efficiency of the affine motion model.

In yet another embodiment, when there is only one MV predictor candidate for each of the middle control points (such as a top-right corner of the left segment, a top-left corner of the right segment, or a same control point for the top-left corner of the right segment and top-right corner of the left segment), the MV predictor candidate is used. When there are multiple MV predictor candidates for the middle control points, then for each MV predictor candidate in a MV predictor candidate list for the current block, one of the MV predictor candidates for the middle control point(s) can be added to the respective MV predictor candidate in the updated MV predictor candidate list for the current block. Using the shared middle control point as an example, the two control points (1721) and (1724) for the current block (1710) is A (e.g., (1721)) and B (e.g., (1724)), and the shared middle control point is M. If the MV predictor candidate list for the current block (1710) includes a candidate 1={a predictor Al for the control point A, a predictor B1 for the control point B} and a candidate 2={a predictor A2 for the control point A, a predictor B2 for the control point B}. Then, the updated MV predictor candidate list includes the updated candidate 1={the predictor Al for the control point A, the predictor B1 for the control point B, a predictor M1 for the control point M}, and the updated candidate 2={the predictor A2 for the control point A, the predictor B2 for the control point B, a predictor M2 for the control point M}. The MV predictor predictors M1 and M2 can be same or different.

The above description of signaling can be suitably adapted to examples when a current block is divided vertically into two segments. For each segment, a motion field including MVs for respective sub-blocks within the segment can be generated using an affine prediction model for the segment. The affine prediction model may be calculated based on MVs at control points of the segment. Each of the MVs can be a sum of a MV predictor and a residual MV component.

The above description for the residual mode can be suitably adapted to the merge mode. In the merge mode, for an affine merge candidate using multiple segments, all control points do not have residual MV components (or the residual MV components are assumed to be zero), and thus, the residual MV components are not signaled.

In one embodiment, dividing a current block into multiple segments is used by default when certain conditions are satisfied. One of the certain conditions may specify that a block size is larger than a threshold. For the current block divided into the multiple segments, motion fields of the current block may be generated by using separate affine motion models for the multiple segments.

In another embodiment, dividing a current block into multiple segments can be used in addition to an affine motion model for the current block when certain conditions are satisfied. One of the certain conditions may specify that a block size is larger than a threshold. Therefore, an affine merge candidate with multiple segments can be generated, in addition to an affine merge candidate with the current block (for example using neighboring block's MVs as control points, or inheriting affine models from a neighboring block). A pair of the affine merge candidates can have different merge indices and can be chosen according to an assigned index.

A current block can be divided into multiple segments by default or when certain conditions are satisfied. The conditions can be applied separately or suitably combined. In an example, a first condition specifies that a block size of the current block is larger than or equal to a first threshold that is a positive integer. The block size can be measured by an area of the current block. The first threshold can be 256 luma samples (e.g., 16×16 samples). The block size can be measured by a length of a longer side of the current block, and the first threshold can be 32 luma samples. The block size can be measured by a length of a shorter side of the current block, and the first threshold can be 16 luma samples.

In another example, a second condition specifies that a ratio of a block width over a block height, or a ratio of the block height over the block width, is greater than or equal to a second threshold. The second threshold can be a positive integer. In an example, when the ratio of the block width over the block height is greater than or equal to 2, the current block is divided horizontally into multiple segments. In an example, when the ratio of the block height over the block width is greater than or equal to 2, the current block is divided vertically into multiple segments.

When both a vertical and a horizontal division are allowed for a current block, certain indication can be used to indicate whether the current block is divided horizontally or vertically.

In the merge mode, separate affine merge candidates including candidates for horizontal divisions and candidates for vertical divisions can be included in a merge candidate list. When an order of the candidates for the horizontal division and the vertical division is agreed by both an encoder and a decoder, no extra signaling is needed.

In the residue mode, for example, when both a vertical and a horizontal division are allowed for a current block, a division flag is signaled to indicate the division direction (i.e., vertical direction or horizontal direction). In an example, when a ratio of a block width over a block height or a ratio of the block height over the block width meets the second threshold, only one division direction is allowed, then the division flag can be inferred and thus, is not signaled.

As described above, samples in a sub-block of a current block have a same MV that is determined based on an affine prediction model for the current block. For an M×N sub-block, M×N samples in the sub-block have the same MV where M and N are positive integers. In an example, a minimal size of the sub-block is M=N=4. In an example, a minimal size of the sub-block is M=4 and N=8. In an example, a minimal size of the sub-block is M=8 and N=4. In an example, a minimal size of the sub-block is M=8 and N=8.

In an example, a MV of a top-left sample in the M×N sub-block that is calculated from an affine prediction model can be used as the MV for all samples in the M×N sub-block. In an example, a MV of a center sample in the M×N sub-block that is calculated from an affine prediction model can be used as the MV for all samples in the M×N sub-block. In an example, a MV of a bottom-right sample in the M×N sub-block that is calculated from an affine prediction model can be used as the MV for all samples in the M×N sub-block.

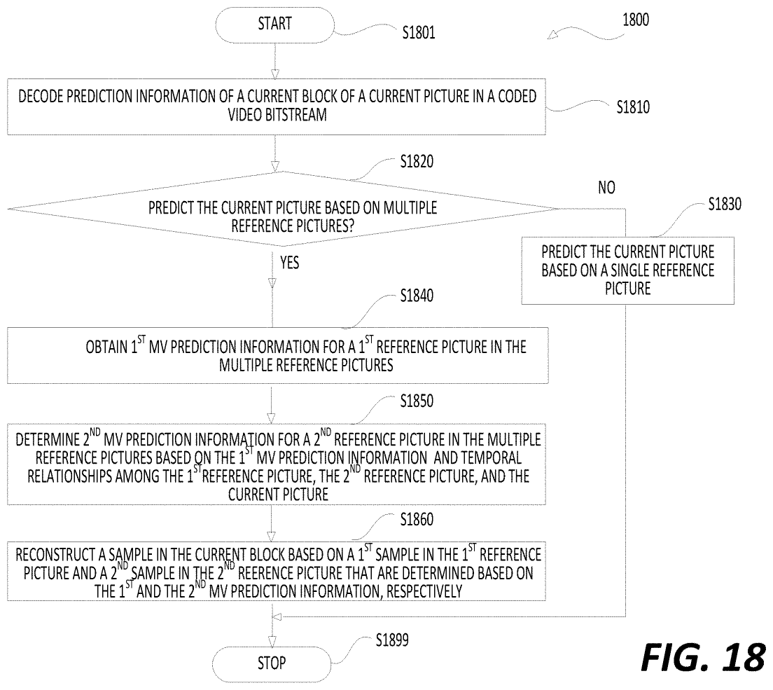

FIG. 18 shows a flow chart outlining a process (1800) according to an embodiment of the disclosure. The process (1800) can be used in the reconstruction of a current block coded in an inter mode (or a motion prediction mode). In various embodiments, the process (1800) are executed by processing circuitry, such as the processing circuitry in the terminal devices (210), (220), (230) and (240), the processing circuitry that performs functions of the video encoder (303), the processing circuitry that performs functions of the video decoder (310), the processing circuitry that performs functions of the video decoder (410), the processing circuitry that performs functions of the video encoder (503), the processing circuitry that performs functions of the predictor (535), and the like. In some embodiments, the process (1800) is implemented in software instructions, thus when the processing circuitry executes the software instructions, the processing circuitry performs the process (1800). The process starts at (S1801) and proceeds to (S1810).

At (S1810), prediction information of a current block of a current picture in a coded video bitstream is decoded. The current block can be a luma block, a chroma block, or the like. The current block can have any suitable shape, size, and the like. The current block can have a rectangular shape according to an embodiment. In an example, the prediction information indicates a motion prediction mode, such as an affine prediction mode, used to code the current block. The prediction information can include an affine flag signaled in the video bitstream to indicate that the motion prediction mode is the affine prediction mode.

At (S1820), whether the current picture is to be predicted based on multiple reference pictures is determined based on the prediction information. For example, when the prediction information includes a prediction flag (e.g., bi-prediction) indicating that the multiple reference pictures are used to predict the current picture, the process (1800) proceeds to (S1840). The multiple reference pictures include a first reference picture and a second reference picture. Otherwise, the process (1800) proceeds to (S1830). In another example, when the prediction information includes a prediction flag indicating that one reference picture is used to predict the current picture, the process (1800) proceeds to (S1830).

At (S1830), the current picture is predicted based on a single reference picture. Samples in the current block can be reconstructed based on the single reference picture and the motion prediction mode using any suitable video coding technologies. Subsequently, the process (1800) proceeds to (S1899), and terminates.

At (S1840), first MV prediction information for the first reference picture is obtained based on the prediction information. The first MV prediction information can include first parameters indicating the motion prediction mode for the first reference picture. When the motion prediction mode is the affine prediction mode, the first MV prediction information can include information of MVs at control points of the current block, a first reference index pointing to the first reference picture in a first reference picture list (e.g., L0), and/or the like, as described above. In an example, the first MV prediction information can include first affine parameters, such as a first scaling factor p for zooming, a first angular factor θ (or a first angular parameter) for rotation, and a first translation MV, (c, f), to describe translation with respect to the first reference picture. Alternatively, the first MV prediction information can include MV predictors and residual MV components of the control points. A subset of the first MV prediction information can be signaled explicitly in the video bitstream or can be derived implicitly based on the prediction information.

At (S1850), second MV prediction information for the second reference picture is determined based on the first MV prediction information and temporal relationships among the first reference picture, the second reference picture, and the current picture, as described above with reference to FIGS. 11A-16.

At (S1860), a sample in the current block is reconstructed based on a first sample in the first reference picture and a second sample in the second reference picture. A first position of the first sample can be determined based on the first MV prediction information, and a second position of the second sample can be determined based on the second MV prediction information. Subsequently, the process (1800) proceeds to (S1899), and terminates.

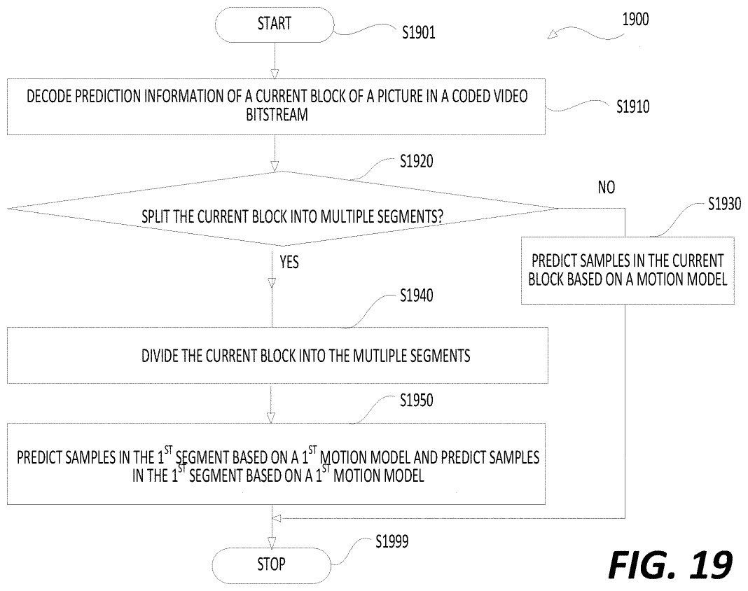

FIG. 19 shows a flow chart outlining a process (1900) according to an embodiment of the disclosure. The process (1900) can be used in the reconstruction of a current block coded in an inter mode (or a motion prediction mode). In various embodiments, the process (1900) are executed by processing circuitry, such as the processing circuitry in the terminal devices (210), (220), (230) and (240), the processing circuitry that performs functions of the video encoder (303), the processing circuitry that performs functions of the video decoder (310), the processing circuitry that performs functions of the video decoder (410), the processing circuitry that performs functions of the video encoder (503), the processing circuitry that performs functions of the predictor (535), and the like. In some embodiments, the process (1900) is implemented in software instructions, thus when the processing circuitry executes the software instructions, the processing circuitry performs the process (1900).

The process (1900) starts at (S1901) and proceeds to (S1910). At (S1910), prediction information of a current block of a picture in a coded video bitstream is decoded. The current block can be a luma block, a chroma block, or the like. The current block can have any suitable shape, size, and the like. The current block can have a rectangular shape according to an embodiment. In an example, the prediction information indicates a motion prediction mode, such as an affine prediction mode, used to code the current block. The prediction information can include an affine flag signaled in the video bitstream to indicate that the motion prediction mode is the affine prediction mode.

At (S1920), whether the current block is to be split into multiple segments is determined based on the prediction information. In an example, the prediction information indicates characteristics of a block size of the current block, such as an area, a block width, a block height, a block width to a block height ratio, and/or the like. When the block size or the block width to the block height ratio is larger than or equal to a threshold, the current block is to be split into the multiple segments. When the current block is determined to be split into the multiple segments, the process (1900) proceeds to (S1940). Otherwise, the process (1900) proceeds to (S1930).

At (S1930), samples in the current block are predicted based on a motion prediction model of the current block. Subsequently, the process (1900) proceeds to (S1999), and terminates.

At (S1940), the current block is divided into the multiple segments based on the prediction information, as described with reference to FIG. 17. In an example, the multiple segments include a first segment and a second segment.

At (S1950), samples in the first segment is predicted based on a first motion prediction model and samples in the second segment is predicted based on a second motion prediction model. Subsequently, the process (1900) proceeds to (S1999), and terminates.

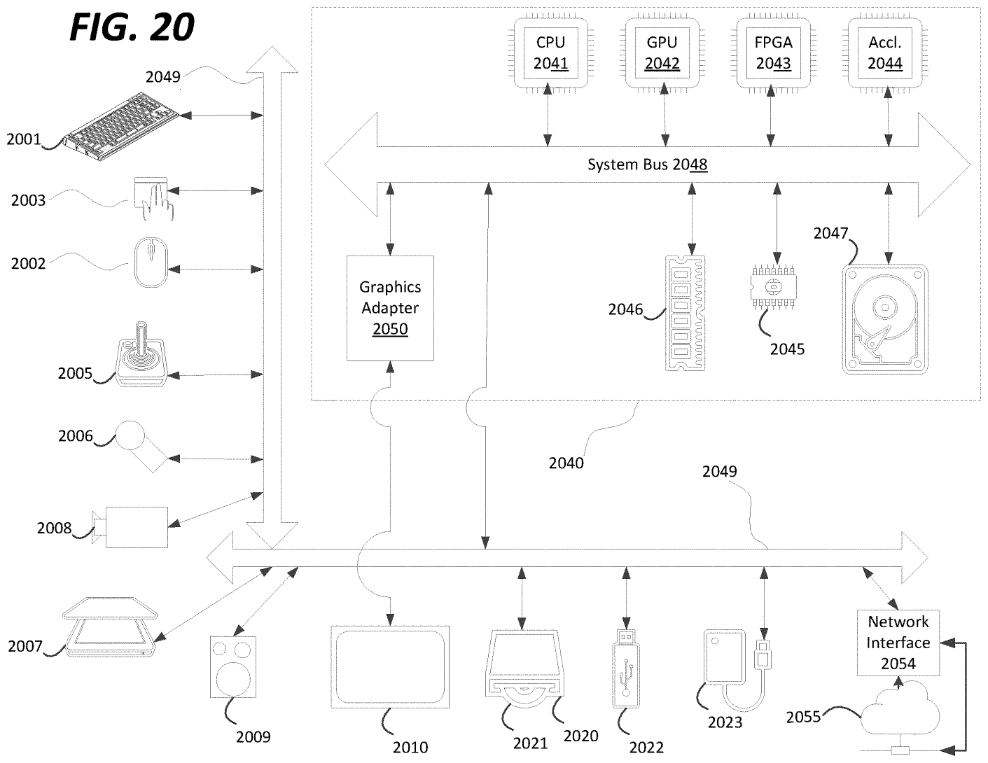

The techniques described above, can be implemented as computer software using computer-readable instructions and physically stored in one or more computer-readable media. For example, FIG. 20 shows a computer system (2000) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 20 for computer system (2000) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (2000).

Computer system (2000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2001), mouse (2002), trackpad (2003), touch screen (2010), data-glove (not shown), joystick (2005), microphone (2006), scanner (2007), camera (2008).

Computer system (2000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2010), data-glove (not shown), or joystick (2005), but there can also be tactile feedback devices that do not serve as input devices), audio output devices (such as: speakers (2009), headphones (not depicted)), visual output devices (such as screens (2010) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (2000) can also include human accessible storage devices and their associated media such as optical media including CD/DVD ROM/RW (2020) with CD/DVD or the like media (2021), thumb-drive (2022), removable hard drive or solid state drive (2023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2000) can also include an interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2049) (such as, for example USB ports of the computer system (2000)); others are commonly integrated into the core of the computer system (2000) by attachment to a system bus as described below (for example Ethernet interface into a PC computer system or cellular network interface into a smartphone computer system). Using any of these networks, computer system (2000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2040) of the computer system (2000).

The core (2040) can include one or more Central Processing Units (CPU) (2041), Graphics Processing Units (GPU) (2042), specialized programmable processing units in the form of Field Programmable Gate Areas (FPGA) (2043), hardware accelerators for certain tasks (2044), and so forth. These devices, along with Read-only memory (ROM) (2045), Random-access memory (2046), internal mass storage such as internal non-user accessible hard drives, SSDs, and the like (2047), may be connected through a system bus (2048). In some computer systems, the system bus (2048) can be accessible in the form of one or more physical plugs to enable extensions by additional CPUs, GPU, and the like. The peripheral devices can be attached either directly to the core's system bus (2048), or through a peripheral bus (2049). Architectures for a peripheral bus include PCI, USB, and the like.

CPUs (2041), GPUs (2042), FPGAs (2043), and accelerators (2044) can execute certain instructions that, in combination, can make up the aforementioned computer code. That computer code can be stored in ROM (2045) or RAM (2046). Transitional data can be also be stored in RAM (2046), whereas permanent data can be stored for example, in the internal mass storage (2047). Fast storage and retrieve to any of the memory devices can be enabled through the use of cache memory, that can be closely associated with one or more CPU (2041), GPU (2042), mass storage (2047), ROM (2045), RAM (2046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2000), and specifically the core (2040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2040) that are of non-transitory nature, such as core-internal mass storage (2047) or ROM (2045). The software implementing various embodiments of the present disclosure can be stored in such devices and executed by core (2040). A computer-readable medium can include one or more memory devices or chips, according to particular needs. The software can cause the core (2040) and specifically the processors therein (including CPU, GPU, FPGA, and the like) to execute particular processes or particular parts of particular processes described herein, including defining data structures stored in RAM (2046) and modifying such data structures according to the processes defined by the software. In addition or as an alternative, the computer system can provide functionality as a result of logic hardwired or otherwise embodied in a circuit (for example: accelerator (2044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

### APPENDIX A: ACRONYMS

JEM: joint exploration model
VVC: versatile video coding
BMS: benchmark set
MV: Motion Vector
HEVC: High Efficiency Video Coding
SEI: Supplementary Enhancement Information
VUI: Video Usability Information
GOPs: Groups of Pictures
TUs: Transform Units,
PUs: Prediction Units
CTUs: Coding Tree Units
CTBs: Coding Tree Blocks
PBs: Prediction Blocks
HRD: Hypothetical Reference Decoder
SNR: Signal Noise Ratio
CPUs: Central Processing Units
GPUs: Graphics Processing Units
CRT: Cathode Ray Tube
LCD: Liquid-Crystal Display
OLED: Organic Light-Emitting Diode
CD: Compact Disc
DVD: Digital Video Disc
ROM: Read-Only Memory
RAM: Random Access Memory
ASIC: Application-Specific Integrated Circuit
PLD: Programmable Logic Device
LAN: Local Area Network
GSM: Global System for Mobile communications
LTE: Long-Term Evolution
CANBus: Controller Area Network Bus
USB: Universal Serial Bus
PCI: Peripheral Component Interconnect
FPGA: Field Programmable Gate Areas
SSD: solid-state drive
IC: Integrated Circuit
CU: Coding Unit

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof

What is claimed is:

1. A method for video decoding in a decoder, comprising:
decoding prediction information of a block of a current picture in a coded video bitstream;
determining a motion prediction mode based on the prediction information;
determining that the block of the current picture is to be predicted based on multiple reference pictures, the multiple reference pictures including a first reference picture and a second reference picture that are in a video sequence including the current picture;
obtaining, based on the prediction information, first motion vector (MV) prediction information for the first reference picture;
determining second MV prediction information for the second reference picture based on the first MV prediction information, the motion prediction mode, and temporal relationships among the first, the second, and the current pictures in the video sequence; and
reconstructing a sample in the block based on a first sample in the first reference picture and a second sample in the second reference picture, a first position of the first sample being determined based on the first MV prediction information, and a second position of the second sample being determined based on the second MV prediction information.

2. The method of claim 1, wherein
the prediction information includes an affine flag indicating that the motion prediction mode is an affine prediction mode, the affine flag being signaled in the coded video bitstream;
the prediction information indicates that both the first and second reference pictures are one of before or after the current picture in the video sequence; and
the temporal relationships among the first, the second, and the current pictures in the video sequence include a first temporal distance of the current picture from the first reference picture and a second temporal distance of the current picture from the second reference picture.

3. The method of claim 2, wherein
the multiple reference pictures further include an additional reference picture that is to the one of before or after the current picture in the video sequence; and
the method further includes:
determining additional MV prediction information for the additional reference picture based on the first MV prediction information, the affine prediction mode, the first temporal distance, and an additional temporal distance of the current picture from the additional reference picture; and
reconstructing the sample in the block further based on an additional sample in the additional reference picture, a position of the additional sample being determined based on the additional MV prediction information.

4. The method of claim 2, wherein
the affine prediction mode is implemented in a merge mode and a merge candidate list includes a first MV prediction candidate for the first reference picture identified in a first picture list; and
the method further includes:
determining, based on the first MV prediction candidate, the affine prediction mode, the first temporal distance, and the second temporal distance, a second MV prediction candidate for the second reference picture identified in a second list; and
generating, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

5. The method of claim 1, wherein
the prediction information includes an affine flag indicating that the motion prediction mode is an affine prediction mode, the affine flag being signaled in the coded video bitstream;
the prediction information indicates that the first and second reference pictures are in opposite directions relative to the current picture in the video sequence;
the first MV prediction information for the first reference picture is signaled in the coded video bitstream; and
the temporal relationships among the first, the second, and the current pictures in the video sequence include a first temporal distance of the current picture from the first reference picture.

6. The method of claim 5, wherein the first temporal distance is equal to a second temporal distance of the current picture from the second reference picture.

7. The method of claim 5, wherein
the affine prediction mode is implemented in a merge mode and a merge candidate list includes a first MV prediction candidate for the first reference picture identified in a first picture list; and
the method further includes:
determining a second MV prediction candidate for the second reference picture identified in a second list based on the first MV prediction candidate, the affine prediction mode, and the first temporal distance; and
generating, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

8. The method of claim 1, wherein
the prediction information includes an affine flag indicating that the motion prediction mode is an affine prediction mode limited to rotation and translation of the block with respect to the first and second reference pictures, the affine flag being signaled in the coded video bitstream;
the prediction information indicates that the first and second reference pictures are in opposite directions relative to the current picture in the video sequence;
the first MV prediction information including a first angular parameter and a first translation MV is signaled in the coded bitstream, the first angular parameter indicating the rotation and the first translation MV indicating the translation of the block with respect to the first reference picture; and
the determining the second MV prediction information includes:
determining the second MV prediction information including a second angular parameter indicating the rotation and a second translation MV indicating the translation of the block with respect to the second reference picture based on the first MV prediction information, the affine prediction mode limited to the rotation and the translation of the block with respect to the first and second reference pictures, and the temporal relationships including a first temporal distance of the current picture from the first reference picture and a second temporal distance of the current picture from the second reference picture.

9. The method of claim 8, wherein
the affine prediction mode is implemented in a merge mode and a merge candidate list includes a first MV prediction candidate for the first reference picture identified in a first picture list; and
the method further includes:
determining a second MV prediction candidate for the second reference picture identified in a second list based on the first MV prediction candidate and the affine prediction mode limited to the rotation and the translation of the block with respect to the first and second reference pictures, the first temporal distance, and the second temporal distance; and
generating, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

10. The method of claim 1, wherein
the prediction information includes an affine flag indicating that the motion prediction mode is an affine prediction mode limited to scaling and translation of the block with respect to the first and second reference pictures, the affine flag being signaled in the coded video bitstream;
the prediction information indicates that the first and second reference pictures are in opposite directions relative to the current picture in the video sequence;
the first MV prediction information including a first scaling parameter and a first translation MV is signaled in the coded bitstream, the first scaling parameter indicating the scaling and the first translation MV indicating the translation of the block with respect to the first reference picture; and
the determining the second MV prediction information includes:
determining the second MV prediction information including a second scaling parameter indicating the scaling and a second translation MV indicating the translation of the block with respect to the second reference picture based on the first MV prediction information, the affine prediction mode limited to the scaling and the translation of the block with respect to the first and second reference pictures, and the temporal relationships including a first temporal distance of the current picture from the first reference picture and a second temporal distance of the current picture from the second reference picture.

11. The method of claim 10, wherein
the affine prediction mode is implemented in a merge mode and a merge candidate list includes a first MV prediction candidate for the first reference picture identified in a first picture list; and
the method further includes:
determining a second MV prediction candidate for the second reference picture identified in a second list based on the first MV prediction candidate and the affine prediction mode limited to the scaling and the translation of the block with respect to the first and second reference pictures, the first temporal distance, and the second temporal distance; and
generating, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

12. An apparatus, comprising processing circuitry configured to:
decode prediction information of a block of a current picture in a coded video bitstream;
determine a motion prediction mode based on the prediction information;
determine that the block of the current picture is to be predicted based on multiple reference pictures, the multiple reference pictures including a first reference picture and a second reference picture that are in a video sequence including the current picture;
obtain, based on the prediction information, first motion vector (MV) prediction information for the first reference picture;
determine second MV prediction information for the second reference picture based on the first MV prediction information, the motion prediction mode, and temporal relationships among the first, the second, and the current pictures in the video sequence; and
reconstruct a sample in the block based on a first sample in the first reference picture and a second sample in the second reference picture, a first position of the first sample being determined based on the first MV prediction information, and a second position of the second sample being determined based on the second MV prediction information.

13. The apparatus of claim 12, wherein
the prediction information includes an affine flag indicating that the motion prediction mode is an affine prediction mode, the affine flag being signaled in the coded video bitstream;
the prediction information indicates that both the first and second reference pictures are one of before or after the current picture in the video sequence; and
the temporal relationships among the first, the second, and the current pictures in the video sequence include a first temporal distance of the current picture from the first reference picture and a second temporal distance of the current picture from the second reference picture.

14. The apparatus of claim 13, wherein
the affine prediction mode is implemented in a merge mode and a merge candidate list includes a first MV prediction candidate for the first reference picture identified in a first picture list; and
the processing circuitry is further configured to:
determine, based on the first MV prediction candidate, the affine prediction mode, the first temporal distance, and the second temporal distance, a second MV prediction candidate for the second reference picture identified in a second list; and
generate, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

15. The apparatus of claim 12, wherein
the prediction information includes an affine flag indicating that the motion prediction mode is an affine prediction mode, the affine flag being signaled in the coded video bitstream;
the prediction information indicates that the first and second reference pictures are in opposite directions relative to the current picture in the video sequence;
the first MV prediction information for the first reference picture is signaled in the coded video bitstream; and
the temporal relationships among the first, the second, and the current pictures in the video sequence include a first temporal distance of the current picture from the first reference picture.

16. The apparatus of claim 15, wherein
the affine prediction mode is implemented in a merge mode and a merge candidate list includes a first MV prediction candidate for the first reference picture identified in a first picture list; and
the processing circuitry is further configured to:
determine a second MV prediction candidate for the second reference picture identified in a second list based on the first MV prediction candidate, the affine prediction mode, and the first temporal distance; and
generate, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

17. The apparatus of claim 12, wherein
the prediction information includes an affine flag indicating that the motion prediction mode is an affine prediction mode limited to rotation and translation of the block with respect to the first and second reference pictures, the affine flag being signaled in the coded video bitstream;
the prediction information indicates that the first and second reference pictures are in opposite directions relative to the current picture in the video sequence;
the first MV prediction information including a first angular parameter and a first translation MV is signaled in the coded bitstream, the first angular parameter indicating the rotation and the first translation MV indicating the translation of the block with respect to the first reference picture; and
the processing circuitry is configured to:
determine the second MV prediction information including a second angular parameter indicating the rotation and a second translation MV indicating the translation of the block with respect to the second reference picture based on the first MV prediction information, the affine prediction mode limited to the rotation and the translation of the block with respect to the first and second reference pictures, and the temporal relationships including a first temporal distance of the current picture from the first reference picture and a second temporal distance of the current picture from the second reference picture.

18. The method of claim 17, wherein
the affine prediction mode is implemented in a merge mode and a merge candidate list includes a first MV prediction candidate for the first reference picture identified in a first picture list; and
the processing circuitry is further configured to:
determine a second MV prediction candidate for the second reference picture identified in a second list based on the first MV prediction candidate and the affine prediction mode limited to the rotation and the translation of the block with respect to the first and second reference pictures, the first temporal distance, and the second temporal distance; and
generate, for the merge candidate list, a bi-prediction candidate that includes the first MV prediction candidate and the second MV prediction candidate, the first MV prediction information corresponding to the first MV prediction candidate and the second MV prediction information corresponding to the second MV prediction candidate.

19. The apparatus of claim 12, wherein
the prediction information includes an affine flag indicating that the motion prediction mode is an affine prediction mode limited to scaling and translation of the block with respect to the first and second reference pictures, the affine flag being signaled in the coded video bitstream;
the prediction information indicates that the first and second reference pictures are in opposite directions relative to the current picture in the video sequence;
the first MV prediction information including a first scaling parameter and a first translation MV is signaled in the coded bitstream, the first scaling parameter indicating the scaling and the first translation MV indicating the translation of the block with respect to the first reference picture; and
the processing circuitry is further configured to:
determine the second MV prediction information including a second scaling parameter indicating the scaling and a second translation MV indicating the translation of the block with respect to the second reference picture based on the first MV prediction information, the affine prediction mode limited to the scaling and the translation of the block with respect to the first and second reference pictures, and the temporal relationships including a first temporal distance of the current picture from the first reference picture and a second temporal distance of the current picture from the second reference picture.

20. A method for video decoding in a decoder, comprising:
decoding prediction information of a block of a picture in a coded video bitstream;
determining that the block is to be split into multiple segments that are predicted with respective affine prediction modes; and
dividing, based on the prediction information, the block into the multiple segments including a first segment and a second segment, samples in the first segment being predicted based on a first affine prediction mode having a first set of parameters, and samples in the second segment being predicted based on a second affine prediction mode having a second set of parameters.
